(19) United States
(12) Patent Application Publication
(10) Pub. No.: US 2026/0296928 A1
(43) Pub. Date: Oct. 1, 2026

(54) METHODS AND SYSTEMS FOR CONTINUOUS PFAS DESTRUCTION

(71) Applicant: Claros Technologies Inc., Minneapolis, MN (US)

(72) Inventors: Terrance P. Smith, Woodbury, MN (US); Brian Breeding, Eden Prairie, MN (US); Terry Lee Potts, Woodbury, MN (US); Elvin Haffez Hossen, Richmond, TX (US); Andrew Thomas Healy, Minneapolis, MN (US); Zekun Liu, Brooklyn Park, MN (US); Joseph Reuel Levine Tirado, Minneapolis, MN (US); Sonja Elise Moons, Minneapolis, MN (US); Evan Bloom, Minneapolis, MN (US); Mia Christine Piro, Minnetonka, MN (US); James McKone, Roseville, MN (US)

(73) Assignee: Claros Technologies Inc., Minneapolis, MN (US)

(21) Appl. No.: 19/703,388

(22) Filed: Jun. 10, 2026

Related U.S. Application Data
(62) Division of application No. 19/395,548, filed on Nov. 20, 2025.
(60) Provisional application No. 63/722,874, filed on Nov. 20, 2024.

(51) Int. Cl. C02F 1/32; C02F 101/36

(52) U.S. Cl. CPC C02F 1/32; C02F 2101/36; C02F 2201/32; C02F 2301/024; C02F 2305/00

(57) ABSTRACT

Methods, systems and devices for lowering a concentration of a PFAS in a solution including exposing a treatment solution to a UV light source from one or more lamps in a continuous reactor, the treatment solution comprising a PFAS, an inorganic ion, and having a pH of about 8 or more, and flowing the treatment solution through the continuous reactor at a flow rate of equal to or greater than 5 gallons per minute while exposing the treatment solution to the UV light. The treatment solution to UV light in the continuous reactor results in partially or fully defluorinating about 80% or more of the PFAS in the treatment solution.

### CROSS REFERENCE TO RELATED APPLICATIONS

This application is a divisional of U.S. application Ser. No. 19/395,548, filed Nov. 20, 2025, entitled “METHODS AND SYSTEMS FOR CONTINUOUS PFAS DESTRUCTION,” which claims priority U.S. Provisional Application No. 63/722,874, filed Nov. 20, 2024, entitled “METHODS AND SYSTEMS FOR CONTINUOUS PFAS DESTRUCTION,” the disclosures of which are hereby incorporated by reference.

### BACKGROUND

Per- and polyfluoroalkyl substances (PFASs) are a class of synthetically prepared compounds that have been used for decades in numerous consumer and industrial applications. PFASs have some unique surface properties and can also be both hydrophobic and oleophobic. As a result, PFASs are used as coating aids, lubricants, foaming aids and various surface treatments. They have proven especially useful as flame retardants in the form of aqueous film-forming foams (AFFF). Also, some PFASs are known to bio-accumulate in plants and animals. There is a growing body of evidence that exposure to PFASs can also cause a variety of health problems. Owing to these concerns, various world-wide regulatory agencies have started to establish strict limits to the presence of PFAS in food and water.

PFASs are a class of chemicals that contain perfluoroalkyl or polyfluoroalkyl groups. The definition and classification of PFASs have changed over time. PFASs are fluorinated substances that contain at least one fully fluorinated methyl or methylene carbon atom (without any H/Cl/Br/I atom attached to it), i.e. with a few noted exceptions, any chemical with at least a perfluorinated methyl group (—CF₃) or a perfluorinated methylene group (—CF₂—) is a PFAS. Some of the most important examples of PFASs include the perfluorosulfonic acids (PFSAs), such as perfluorooctanesulfonic acid (PFOS) and the perfluorocarboxylic acids (PFCAs) like perfluorooctanecarboxylic acid (PFOA). Fluorotelomers are fluorocarbon-based oligomers, or telomers, synthesized by telomerization. Some fluorotelomers and fluorotelomer-based compounds are a source of environmentally persistent perfluorinated carboxylic acids such as PFOA.

The persistence of PFASs, the health issues, and the regulatory landscape have prompted a great deal of research effort to reduce their presence in the environment. Much of the early work was focused on capture, for example from drinking water. However, more recently, there has been a stronger effort on the destruction of these materials. One of the attributes of PFASs is their resistance towards breaking down in the environment. PFASs are not easily metabolized by organisms, and do not decompose by exposure to visible light or longer wavelength UV irradiation typically found under terrestrial conditions.

Some of the methods that have proven effective for breaking down PFASs are supercritical water oxidation (SCWO) and treatment of PFASs in an aprotic polar solvent. SCWO works by heating water to 3740 Celsius under high pressure (over 3000 psi). Therefore, SCWO is quite energy intensive and can suffer from clogging issues. The use of SCWO often requires wastes containing high solids because it relies on the heat capacity (btu) generated from this waste to make the process cost effective. An advantage of SCWO is its short residence time to be effective, on the order of 30 seconds to minutes. The use of basic aprotic media to destroy PFASs suffers from the fact that most waste streams are water-based and therefore not readily transferred to aprotic media that requires minimum water levels. In other cases, generating subcritical water conditions in alkaline environments has also been shown to destroy PFAS compounds. This process, referred to as hydrothermal alkaline treatment (HALT), operates at temperatures around 3500 Celsius and pressures around 2400 psi.

Other processes for destroying PFASs involve the use of electrochemistry. Electrochemical destruction can destroy long chain PFASs (for example, PFOS and PFOA), however, shorter chain PFASs are less prone to destruction. It is speculated that the longer chained PFASs readily assemble on the electrodes and therefore can be readily oxidized or reduced. Other work has shown that sonication can result in PFAS destruction.

Improved processes are needed to efficiently and effectively destroy PFAS, particularly PFAS in water.

### SUMMARY

Various embodiments include methods, systems and devices for lowering a concentration of a PFAS in a solution. In some embodiments, the method of lowering the concentration of a PFAS in a solution includes exposing a treatment solution to a UV light source from one or more lamps in a continuous reactor, the treatment solution comprising a PFAS, an inorganic ion, and having a pH of about 8 or more, and flowing the treatment solution through the continuous reactor at a flow rate of equal to or greater than 5 gallons per minute while exposing the treatment solution to the UV light, wherein exposing the treatment solution to UV light in the continuous reactor results in partially or fully defluorinating about 80% or more of the PFAS in the treatment solution.

In some embodiments of the method described above, the flow rate may be between about 5 gpm and about 100 gpm. The ultraviolet light source emits light predominantly at a wavelength between about 150 nm and about 300 nm. In some embodiments, the ultraviolet light source emits light predominantly at a wavelength between about 200 nm and about 300 nm. The inorganic ion may be present at a concentration of at least about 0.1 mM in the treatment solution. In some such embodiments, the inorganic ion may be iodide, sulfite, bromide, chloride, or sulfate. For example, the inorganic ion may be iodide and/or sulfite. In embodiments in which the inorganic ion includes iodide and sulfite, the iodide may be present at a concentration of between about 0.1 mM to 5 mM and the sulfite may be present at a concentration of between about 0.1 mM to about 20 mM in the treatment solution, or the iodide concentration may be between about 0.25 mM to about 2 mM and the sulfite concentration may be between about 0.5 mM and about 5 mM, or the sulfite concentration may be between about 0.5 and about 10 mM, in the treatment solution. In various embodiments, after exposing the treatment solution to the UV light source, the PFAS may be present in the treatment solution at a concentration between about 10 ppt and about 500 ppm. In some embodiments, after exposing the treatment solution to the UV light source, the PFAS may be present in the treatment solution at a concentration between about 10 ppt to 100 ppm PFAS.

In various embodiments of the methods described above, the UV light source may be supplied by electrical power of greater than about 3000 watts. In some embodiments, the electrical power may be greater than about 10000 watts. In some embodiments, the electrical power may be greater than about 30000 watts. In some embodiments, the electrical power may be between about 3000 watts and about 200,000 watts.

In the methods of lowering PFAS described above, exposing the treatment solution to UV light in the continuous reactor may result in partially or fully defluorinating about 90% or more of the PFAS in the treatment solution. In some embodiments, exposing the treatment solution to UV light in the continuous reactor may result in partially or fully defluorinating about 99% or more of the PFAS in the treatment solution. In some embodiments, exposing the treatment solution to UV light in the continuous reactor may result in partially or fully defluorinating about 99.9 or more of the PFAS in the treatment solution.

Various methods of lowering a concentration of PFAS in a solution include exposing a treatment solution to a UV light source in a continuous reactor including one or more lamps, an inlet, an outlet, and one or more mixing baffles, with the treatment solution including a PFAS, iodide and sulfite, and having a pH of about 8 or more. The method further includes flowing the treatment solution through the continuous reactor from the inlet to the outlet at a flow rate of equal to or greater than 5 gallons per minute while exposing the treatment solution to the UV light. Exposing the treatment solution to UV light in the continuous reactor may result in partially or fully defluorinating about 80% or more of the PFAS in the treatment solution.

In some of the methods in which the continuous reactor includes baffles, such as the methods described above, the continuous reactor may have a longitudinal axis, and the one or more mixing baffles may include plates positioned approximately perpendicular to the longitudinal axis. In some embodiments, the one or more mixing baffles may include between 1 and 20 mixing baffles, or between 2 and 20 mixing baffles. In some embodiments, the one or more mixing baffles may include a plurality of baffles in which there are between 1 and 3 mixing baffles per unit of lineal length of the reactor which is equal to the reactor diameter. The one or more mixing baffles may have an open area and a closed area, with the open area including between about 5 and about 80% of the cross-sectional area of the continuous reactor across which the mixing baffle extends. In some such embodiments, the one or more mixing baffles may include a plurality of openings which are circular and/or oval in shape and between about 0.1 cm and about 10 cm in diameter.

Various embodiments include a photochemical method of partially or fully defluorinating a PFAS including flowing a treatment solution comprising a PFAS and an inorganic ion through a first photoreactor at a flow rate of at least about 5 gallons per minute and exposing the treatment solution to UV light in the first photoreactor, and then flowing the treatment solution through a second photoreactor at a flow rate of at least about 5 gallons per minute and exposing the treatment solution to UV light in the second photoreactor. Greater than about 90% of the PFAS present in the treatment solution may be partially or fully defluorinated after flowing the treatment solution through the second photoreactor. In some embodiments, greater than about 99% of the PFAS present in the treatment solution may be partially or fully defluorinated. In some embodiments, greater than about 99.9% of the PFAS present in the treatment solution may be partially or fully defluorinated.

In some embodiments, the photochemical method of partially or fully defluorinating a PFAS also includes, after flowing the treatment solution through the second photoreactor, flowing the treatment solution through a third photoreactor at a flow rate of at least 5 gallons per minute and exposing the treatment solution to UV light in the third photoreactor. In some embodiments, the method further includes increasing or decreasing a concentration of inorganic ions in the treatment solution after flowing the treatment solution through the first photoreactor and before exposing the treatment solution to UV light in the second photoreactor.

In some embodiments of the photochemical method of partially or fully defluorinating a PFAS, the inorganic ion includes iodide and/or sulfite. In some embodiments, the inorganic ion includes sulfite, and the method further includes increasing or decreasing a concentration of sulfite and the pH of the treatment solution after flowing the treatment solution through the first photoreactor and before exposing the treatment solution to UV light in the second photoreactor. In some such embodiments, increasing or decreasing the concentration of the sulfite includes decreasing the concentration of the sulfite by applying an oxidative process to the treatment solution. In some embodiments, the sulfite concentration may be decreased by applying an electrochemical oxidation process to the treatment solution. In some embodiments, the sulfite concentration may be decreased by applying a chemical oxidation process to the treatment solution. The chemical oxidation process may include exposing the treatment solution to oxygen, ozone, hypochlorite, and/or peroxide, for example. The chemical oxidation process may include exposing the treatment solution to peroxide, wherein the peroxide is a hydrogen peroxide, ter-butyl hydroperoxide or peroxyacetic acid, for example. The chemical oxidation process may include a catalytic oxidation including exposing the treatment solution to a metal catalyst. In some embodiments, increasing or decreasing the sulfite concentration includes decreasing the sulfite concentration by a combination of oxidizing the sulfite by exposing the treatment solution to oxygen and applying UV light to the treatment solution. In some embodiments, the sulfite concentration is reduced or eliminated and then sulfite concentration is re-adjusted by the addition of a sulfite salt after flowing the treatment solution through the first photoreactor and before exposing the treatment solution to UV light in the second photoreactor.

Various embodiments include systems for partially or fully defluorinating a PFAS solution including a first continuous photoreactor, a device configured to modify a concentration of an inorganic ion concentration in a treatment solution, wherein the device is configured to receive the treatment solution from the first photoreactor, and a second continuous photoreactor configured to receive the treatment solution from the device after modifying the concentration of the inorganic ion in the treatment solution.

### BRIEF DESCRIPTION OF THE DRAWINGS

The following drawings are illustrative of embodiments and do not limit the scope of the invention. The drawings are not necessarily to scale and are intended for use in conjunction with the following detailed description. Various embodiments will be described with reference to the drawings, in which like numerals may represent like elements.

FIG. 1 is a schematic showing a PFAS destruction reactor system diagram according to various embodiments;

FIG. 2 is a schematic showing a PFAS destruction reactor system diagram according to other embodiments;

FIG. 3 is an example of a photoreactor without modification of the inlet and outlet ports;

FIG. 4 is a cross-sectional view of an array of light sources as used in a UV photoreactor according to various embodiments. The lighter area represents higher light intensity;

FIG. 5 is an image of a UV light support system according to various embodiments;

FIG. 6 is an image of the UV light support system of FIG. 5 with the lamp sleeves removed;

FIG. 7 is an image of the perforated disks of the UV light support system of FIG. 5;

FIG. 8 is an image of one configuration of a perforated disk of the UV light support system of FIG. 5;

FIG. 9 is an image of an alternative configuration of a perforated disk of the UV light support system of FIG. 5;

FIG. 10 is a graph showing a summary of literature concerning sulfite and iodide use, separately or together, for the treatment of perfluorocarboxylic and perfluorosulfonic materials under UV 254 nm irradiation;

FIG. 11 is schematic flow diagram of a serial reactor system with a device between reactors for modifying the sacrificial reductant concentration via chemical addition ports;

FIG. 12 is schematic flow diagram of a serial reactor system with a device between reactors for modifying the sacrificial reductant concentration via an electrochemical device;

FIG. 13 is schematic flow diagram of a serial reactor system with a device between reactors for modifying the sacrificial reductant concentration via a photochemical device; and

FIG. 14 is schematic flow diagram of a serial reactor system with a device between reactors for modifying the sacrificial reductant concentration via a photochemical device followed by a port for redosing the solution with reagents before flow into an additional reactor.

FIG. 15 is a graph of PFBA destruction percentage at varied reagent dosing versus time;

FIG. 16 is a graph of PFBA concentration in influent in ppb and effluent in ppt versus time under two reaction conditions according to one example;

FIG. 17 is a graph of PFBA concentration in influent in ppb and effluent in ppt versus time under various reaction conditions according to another example;

FIG. 18 is a graph of PFBA concentration with influent in ppb and effluent in ppt versus time under various reaction conditions according to still another example;

FIG. 19 is a diagram of an 18 GPM sequential destruction process;

FIG. 20 is a graph of PFBA concentration in influent in ppb and effluent in ppt versus time under various reaction conditions including a first pass and a second pass through a continuous reactor;

FIG. 21 is a graph of a model of destruction of PFAS at a concentration 0.1× concentration over a range of sulfite and iodide concentrations;

FIG. 22 is a graph of a model of PFAS destruction of FIG. 21 over a broader range of sulfite and iodide concentrations;

FIG. 23 is a graph of a model of PFAS destruction of FIGS. 21 and 22 over an even broader range of sulfite and iodide concentrations;

FIG. 24 is a graph of a model destruction of PFAS at a concentration of 1× concentration over a range of sulfite and iodide concentrations;

FIG. 25 is a graph of a model of PFAS destruction of FIG. 24 over a broader range of sulfite and iodide concentrations;

FIG. 26 is a graph of a model of PFAS destruction of FIGS. 24 and 25 over an even broader range of sulfite and iodide concentrations;

FIG. 27 is a graph of a model destruction of PFAS at a concentration of 5× concentration over a range of sulfite and iodide concentrations;

FIG. 28 is a graph of a model of PFAS destruction of FIG. 27 over a broader range of sulfite and iodide concentrations;

FIG. 29 is a graph of a model of PFAS destruction of FIGS. 27 and 28 over an even broader range of sulfite and iodide concentrations;

FIG. 30 is a graph of a model destruction of PFAS at a concentration of 100× concentration over a range of sulfite and iodide concentrations;

FIG. 31 is a graph of the model of PFAS destruction of FIG. 30 over a broader range of sulfite and iodide concentrations;

FIG. 32 is a graph of the model of PFAS destruction of FIGS. 30 and 31 over an even broader range of sulfite and iodide concentrations;

FIG. 33 is a graph of destruction efficiency as a function of sulfite range for a PFAS level of about 250 ppb;

FIG. 34 is a graph of destruction efficiency as a function of sulfite range for a PFAS level of about 2.5 ppm;

FIG. 35 is a graph of destruction efficiency as a function of sulfite range for a PFAS level of about 12.25 ppm;

FIG. 36 is a graph of destruction efficiency as a function of sulfite range for a PFAS level of about 250 ppm;

FIG. 37 is a graph of normalized concentration vs time for three representative PFAS species based on kinetic model predictions in the well-mixed batch reactor shown in Example 7;

FIG. 38 is a plot of longitudinal velocity vs position relationship in a 7.5 cm diameter×25 cm long UV reactor vessel containing a single light bulb;

FIG. 39 is a plot of integral residence time distribution, plotted as cumulative percent fluid volume vs time, for a UV reactor system approximately 1 L in internal volume with continuous flow at the different volumetric flow rates;

FIG. 40 is a plot of integral residence time distributions for 7.5 cm diameter UV reactors with the noted overall lengths and flow rates increasing proportionally to the length, from 55 mL/min for the 25 cm length reactor to 440 mL/min for the 200 cm length reactor;

FIG. 41 is a plot of integral residence time distributions for 100 cm long UV reactors with the noted diameters and flow rates increased in proportion to the cross-sectional area, from 220 mL/min for the 7.5 cm dia. reactor to 11.6 L/min for the 60 cm diameter reactor;

FIG. 42 is a plot of integral residence time distributions for 100 cm long by 7.5 cm diameter UV reactors with baffles designs as annotated and a water flow rate of 220 mL/min;

FIG. 43 is a plot of post-GAC flow rate test results using a photoreactor with an approximately 70 cm in inner diameter that is 2 m in length;

FIG. 44 is a plot of the modeled destruction of 250 ppm PFBA parent compound in a two-stage serial reactor system;

FIG. 45 is a plot of the modeled de-fluorination of 250 ppm PFBA in a two-stage serial reactor system;

FIG. 46 is a schematic flow diagram of a two-stage serial reactor system with intermediate sulfite quench;

FIG. 47 is a photograph of a two-stage serial reactor system with intermediate sulfite quench and re-dose system; and

FIG. 48 is a plot of results from a study of PFBA destruction through a two-stage serial flow reactor system with an intermediate sulfite quench and re-dose.

### DETAILED DESCRIPTION

The systems and methods described herein relate to processes for the photochemical destruction of PFASs using UV photolysis. The UV photolysis is based on generating a highly reducing species, such as solvated electrons, produced by the irradiation of a photosensitizer. The photosensitizer absorbs UV energy and generates a solvated electron and an oxidized photosensitizer species. The solvated electrons can react with a PFAS molecule. In some embodiments, UV photolysis may include oxidative processes.

Various embodiments include processes to increase the efficiency of the photochemical destruction of PFAS and allow photochemical methods to be more generally used on a variety of PFAS-containing waste streams, including efficiently reducing PFAS to very low levels. Other embodiments include UV photolysis reactor designs such as continuous reactor designs to accomplish more efficient destruction of PFASs.

Various embodiments include photochemical destruction of PFASs as a method to destroy the so-called “Forever Chemicals”. In some embodiments, the photochemical system includes a reactor vessel, or a plurality of reactor vessels with one or more UV light sources. The reactor may be charged with a solution consisting of one or more PFAS, water (or another solvent), base, and photosensitizers capable of absorbing UV light and producing a reactive species. In addition, there optionally may be one or more other chemical additives to promote the reaction. The process, systems and methods disclosed herein may result in improved efficiencies, lower costs, and use of less chemicals.

In some embodiments, the UV photolysis systems and methods may be used to treat PFAS present in wastewater or other water sources directly, such as without isolation or concentration of the PFAS in the wastewater or other water source, such as in a high throughput treatment system. In other embodiments, the UV photolysis systems and methods may be used to treat PFAS which has been extracted or absorbed and isolated and/or concentrated from the environment, such as from wastewater or other water sources. This PFAS may be suspended or dissolved into an aqueous solution for use in the UV photolysis methods and systems described herein.

The methods and systems of PFAS destruction described herein include the ability to destroy PFAS contaminants, including carboxylated and sulfonated PFAS contaminants. Examples of PFAS which may be destroyed by the embodiments described herein include but are not limited to Trifluoroacetic Acid (TFA), Perfluorobutanoic acid (PFBA), perfluoropentanoic acid (PFPeA), Perfluorohexanoic acid (PFHxA), Perfluorooctanoic acid (PFOA), Perfluorobutanesulfonic acid (PFBS), Perfluorohexanesulfonic acid (PFHxS) and Perfluorooctanesulfonic acid (PFOS). More than one type of PFAS may be treated and destroyed simultaneously using the photoreaction methods described herein.

Destruction of the PFAS includes a change in the identity of the target chemical pollutant through the cleavage of chemical bonds. Destruction that yields complex chemical compounds as final products is referred to as degradation. Destruction includes removing one or more chemical groups which may reduce or eliminate toxicity. The cleavage of chemical bonds between carbon and fluorine is further referred to as defluorination. PFAS destruction may proceed through partial or full defluorination, which comprises cleavage of one carbon-fluorine bond or multiple carbon-fluorine bonds to the limit of all carbon-fluorine bonds in the target PFAS pollutant.

The PFAS used in various embodiments may be in aqueous solution, such as PFAS present in a water from a contaminated natural source or other source or may be concentrated by a prior capture or pretreatment method or other treatment method. PFASs are found in many waste streams, and any of these waste streams may be treated using the methods and systems described herein. Some common PFAS-containing waste streams that may be treated according to various embodiments include effluent from industrial producers of PFASs, effluent from textiles plants, foam fractionation concentrates, Aqueous Film-Forming Foams (AFFF), AFFF rinsates, landfill leachates, contaminated ground water, municipal water waste streams, and pot still bottoms.

UV reactors used in various embodiments may include one or more continuous reactors, a semi-continuous reactor, and/or one or more batch reactors. In various embodiments, a semi-continuous includes a reactor that combines elements of both batch and continuous reactors. For example, a semi-continuous reactor may include a batch type of reactor into which reactants are continuously added during operation. In a semi-continuous mode of operation, some reactants may be loaded into the reactor initially while others may be added intermittently or continuously during the reaction process, and some products may also be removed during the reaction, for example. In some embodiments, the system for the UV destruction of PFAS may include a single reactor vessel in which pretreatment, photolysis, and the post-treatment steps are sequentially performed. In other embodiments, one or more or all of the steps of pre-treatment, photolysis, and post treatment may occur in separate vessels or chambers of a vessel, such as for continuous processes. In some embodiments, the UV photolysis process may be performed using one or more reactor vessels, including batch reactors and/or continuous reactor vessels, with one or more UV light sources. The reactor may be charged with wastewater that may optionally be pretreated and includes PFAS, water, and photosensitizers capable of absorbing UV light and producing a reactive species. In addition, there optionally may be one or more other chemical additives to promote the reaction.

The reactor vessel may include one or more UV light sources emitting light, such as UV light predominantly at a wavelength of 222 nm, or 254 nm. In some embodiments, multiple wavelengths may be emitted from a light source, or from various light sources, and other wavelengths of lights in addition to 222 nm and 254 nm may contribute to PFAS photoreduction, such as 185 nm.

The photoreactor may be used alone, or in combination with other reactors, such as in series, which may employ a photoreduction at the same or different wavelength or may employ other PFAS destruction methodologies. Alternatively, one or more steps may be performed in the same vessel.

Examples of PFAS capture systems, treatment systems, pretreatment systems and posttreatment systems are provided in the applicant's other applications, such as U.S. patent application Ser. No. 18/212,603, entitled METHOD AND APPARATUS FOR THE DESTRUCTION AND DEFLUORINATION OF PER- AND POLYFLUOROALKYL SUBSTANCES (PFAS), FLUOROTELOMERS AND OTHER PERSISTENT ORGANIC POLLUTANTS filed Jun. 21, 2023, U.S. Pat. App. No. 63/513,782 entitled PROCESSES FOR EFFICIENT PHOTOCHEMICAL DESTRUCTION OF PFAS FROM WASTE STREAMS filed Jul. 14, 2023, and U.S. patent application Ser. No. 18/555,135 entitled SORBENTS AND METHODS FOR THE CAPTURE AND DEFLUORINATION OF PER AND POLY FLUOROALKYL SUBSTANCES (PFAS) filed Oct. 12, 2023 (national stage entry), and U.S. Pat. No. 12,473,222 METHODS AND SYSTEMS FOR RECYCLING MATERIALS DURING PFAS DESTRUCTION filed Jul. 12, 2024, the disclosures of all of which are hereby incorporated by reference. The systems and methods described herein may be used in combination with the methods and systems described in these applications.

One example of a photoreactor which may be used in various embodiments comprises one or more lamps, such as lamps including cylindrical bulbs or other bulb shapes, and one or more photoreactor vessels configured such that the light of the lamp will project onto the contents of the reactor vessel or vessels. A lamp can contain one bulb or multiple bulbs and may further incorporate external bulb housings, support structures, electrical connections, and/or optically transparent protective sleeves. The lamps may be supported on a frame such as a metal support frame, at a desired distance over a top surface of a photoreactor vessel and/or above the top surface of liquid in the photoreactor vessel when in use to shine directly on the surface of the reaction solution or to shine through the reactor vessel wall. Alternatively, the lamp may fit into the reactor vessel to shine light directly onto the contents from within the reactor vessel. The bulb may be protected and/or separated from the reaction solution within the reactor vessel, such as by a transparent sleeve or other transparent barrier. In some embodiments, the photoreactor vessel may include two or more cylindrical lamps, such as between 5 and 150 low pressure lamps or between 10 and 100 low pressure lamps, or between land 20 medium pressure lamps, or between 2 and 10 medium pressure lamps, and a support frame holding the lamps horizontally at a selected distance above a level surface of a photoreactor vessel or within sleeves submersed within the treatment solution. Other light and reactor vessel configurations and orientations may be used to optimize energy delivery and PFAS destruction. Furthermore, in various embodiments, the photoreactor could be a tube reactor like the continuous photoreactors described herein, but it may or may not be horizontally oriented. Rather, the tube and lamps could be vertically oriented or could be oriented at an angle between horizontal and vertical.

The photoreactor vessel may be any appropriate material such as quartz or other material which is non-reactive and is transparent to the wavelength of light used for the PFAS destruction. In other embodiments, such as those in which the bulb is located within the reactor vessel, the reactor vessel need not be transparent and may be a nontransparent and nonreactive material such as stainless steel. The vessel may be configured to contain a fluid and may include a top which may seal the vessel and/or inlet and outlet ports. The reactor vessel may be any size or shape. In some embodiments, the reactor vessel is cylindrical. The lamp(s), lamp support, and the reactor vessel may be contained in a housing such as a metal enclosure or other enclosure.

Examples of lamps which may be used in various embodiments include krypton/chloride excimer lamps emitting radiation at a peak of 222 nm. Other excimer lamps which emit a narrow band of radiation at other wavelengths could alternatively be used. The power supply to the lamps may be 20 kilovolts or may be more or less than 20 kilovolts. The low-pressure lamps may consume 100 Watts of power or could consume more or less power, such as 150 Watts, 300 Watts, 600 Watts, 800 Watts, or 1500 Watts. In some embodiments, the lamp powers for lamps including those emitting UV light at a peak of 222 nm and 254 nm, for example, may be between about 50 and about 5000 W, such as between about 100 and about 1500 W or between about 100 and about 600 W. This can include medium pressure bulbs that may be between 400 W to 60,000 W. Single lamps may be used or multiple lamps, which may be identical or different.

The photoreaction methods as described herein may be performed at room temperature or at a temperature greater than room temperature. For example, in some embodiments, the temperature of the photoreactor may be between about 550 Celsius and about 600 Celsius during the reaction. However, higher or lower temperatures could alternatively be used. In addition, heating and/or cooling elements could be added to the reactor and/or to the room containing the reactor to raise or lower the temperature, such as air-ducting, fans, and lamps.

The reactor solution may be stationary during UV treatment, or it may be agitated, or it may flow past the lamps such as in a continuous flow cylindrical reactor. For example, the reactor may include stirrers or agitators with the capacity to stir or agitate the solutions. Alternatively, during UV treatment, the solution may enter the reactor flowing continuously through an inlet at one end, flow continuously through the reactor between and around the UV lights and exit the reactor still flowing continuously. In some embodiments, stirring or agitating the reactor solution, or the flow of the solution through the reactor, during irradiation, may facilitate exposure of PFAS compounds to regions of higher radiation. In some embodiments, the solution may be recirculated through a heat exchange unit. The UV reactor may further include a sensor module configured to allow continuous monitoring of the physical and/or chemical state of the reaction solution. The sensor system in some embodiments has one or more sensors configured to monitor one or more of the following: temperature, pressure, pH, UV intensity, fluoride ion concentration, turbidity, hardness, ionic strength, dissolved oxygen concentration, oxidation-reduction potential, and the concentration any of various species relevant to the UV PFAS destruction process. In some embodiments, the UV reactor may also include one or more ports for adding additional reagents and/or sampling the reaction mixture. The additives charged from the ports can be added to the treatment solution continuously and/or in one or more batches, within the reactor and/or upstream of the reactor.

Some embodiments result in complete destruction of the PFAS or near complete destruction, such as greater than 99% destruction. Some embodiments result in at least 80% or at least 90% or at least 95% destruction of PFAS, such as about 90% to about 100%, or about 95% to about 100% destruction of PFAS. Destruction refers to partial or full defluorination of one or more PFAS species. For example, in some embodiments, PFAS levels may be reduced to less than 100 ppt or less than 50 ppt, such as between about zero or about 1 ppt and about 100 ppt, or between about zero or about 1 ppt and about 50 ppt.

Various embodiments include a photosensitizer which may be added to the wastewater. The photolysis method includes generating a highly reducing species, such as a solvated electron, produced by the irradiation of a photosensitizer. Photosensitizers which may be used in various embodiments include halides, pseudo halogens, inorganic oxoanions, anionic metal complexes, metal clusters, Zintl Compounds, nanometal particles of transition metals, organic anions, nitrogen heterocycles, boron-doped nanodiamonds, and/or nitrolotriacetic acid. These photosensitizers may be used in combination or separately in conjunction with different light sources. Examples of halides which may be used include iodide, chloride, and bromide. Examples of pseudohalogens which may be used include cyanide, isocyanate, cyanate, isocyanide, isocyanate, azide, hydroxide, hydrosulfide, hydroselenide, hydrotelluride, fulminate, thiocyanate, selenocyanate, tellurocynate, isothiocyanate, nitroxide, tetracarbonyl colbaltate, trinitromethanide, tricyanomethanide, 1,2,3,4-thiatriazol-5-thiolate, fulminate, cyaphide, and auride. Examples of inorganic oxoanions which may be used include sulfite (SO₃²⁻), sulfate (SO₄²⁻), hyposulfite (SO₂₂) thiosulfate (S₂O₃²⁻), carbonate (CO₃²⁻), phosphate (PO₄³⁻), phosphite (PO₃³⁻), hypophosphite (PO₂³), and borate (BO₃³⁻), including protonated forms of these anions (e.g. HSO₃⁻, HSO₄⁻, HCO₃⁻). Examples of anionic metal complexes which may be used include ferricyanide ion, ferrioxalate ion, tetrachloroplatinate ion, hexachloroiridate ion, cyanocuprates and cerium(III) complexes). Examples of metal clusters that may be used include Mo₆Cl₁₄²⁻, Zr₆CCl₁₂⁴⁻, Ta₆Cl₁₈⁴⁻, Re₃Cl₁₂³⁻, and iron sulfur clusters. Examples of Zintl Compounds that may be used include [Bi₃]³⁻, [Sn₉]⁴⁻. Examples of nanometal particles of transition metals that may be used include gold, copper, and iron. Examples of organic anions that may be used include ascorbic acid anion, ascorbic acid dianion, phenolates, cresolates, dihydroybenzenes anions, methoxyphenolates, thiophenolates. Examples of nitrogen heterocycles that may be used include indole-3-acetic acid.

Other components which may be included in the reactor include photosensitizers such as halide salts alone or in combination with other components such as reductants such as sulfites. Sulfite can be used as a reductant, as a photosensitizer, or both as a reductant and photosensitizer. In some embodiments, sulfite can be used alone as a photosensitizer without additional photosensitizers such as with UV light treatment at 185 nm and 222 nm. The concentration of the photosensitizer may depend on the electronic absorption spectra of the photosensitizer, the spectral output of the lamp, the concentration of other photosensitizers contained within the reactor, and the concentration of PFAS within the solution, for example.

In some examples, components which may be included in the reactor with the PFAS solution include halide salts alone or in combination with other components such as sulfites. In some embodiments, such as embodiments utilizing UV222 nm or UV254 nm light, KI and Na₂SO₃, may be included in the reactor solution. In some embodiments, it is preferable to maintain an alkaline pH during photoreduction, such as a pH of about 8 or more, or about 9 or more, or about 10 or more, or about 11 or more, or about 12 or more, or about 13 or more. Therefore, in addition to the reagents discussed above, it may be useful to include a base such as sodium carbonate and/or one or more other bases such as sodium hydroxide to increase the efficiency of the reaction.

Low pressure mercury lamps, medium pressure mercury lamps, and mercury amalgam lamps (in or out of arc) may be used as the source of UV radiation in various embodiments because of their relatively low cost and high efficiency of converting electrical energy into UV photons. Mercury vapor lamps exhibit pronounced spectral lines in the ultraviolet and visible. For PFAS destruction, 184.5 nm (typically referred to as 185 nm) and 253.7 nm (typically referred to as 254 nm) are important wavelengths. However, other light sources can also be used in various embodiments. In particular, various excimer lamps which have high efficiency, high-powered, narrow-band radiation across the UV spectrum (near UV to Vacuum UV) are also excellent light sources and may be used in various embodiments. Excimer lamps are a type of discharge lamp that involves rare gases such as argon (Ar), krypton (Kr) or Xenon (Xe), or halogen dimers (F₂, Cl₂ Br₂ or I₂) or combinations of halogens and rare gases. The UV light from an excimer source is due to emission from the excited state of rare gas dimer (Ar₂*, Kr₂* and Xe₂*), halogen dimers (F₂*, Cl₂* Br₂* or I₂*) and rare-gas halide excimers (ArF*, ArCl*, ArBr*, ArI*, KrF*, KrCl*, KrBr*, KrI*, XeF*, XeCl*, XeBr* and XeI*), where the asterisk denotes an excited state. Examples of excimers light sources and their principle emission output that may be used in various embodiments include XeXe* (172 nm), ArCl* (175 nm), KrI* (190 nm), ArF* (193 nm), KrBr* (207 nm), KrCl* (222 nm), KrF* (248 nm), XeI (253 nm), Cl₂* (259 nm), XeBr*, Br₂* (289 nm) and XeCl* (308 nm). In some embodiments, preferred lamps may have outputs between 172 nm and 289 nm, for example. The wavelength output and availability of powerful KrCl* excimer lamps make them especially preferred in certain embodiments. Although the efficiencies of excimer lamps may not be as high as the efficiencies from mercury lamps, the ability to fine tune the light emission to a given photosensitizer is useful to the overall effectiveness of photochemical process in various embodiments. These lamps have the added advantage of not containing mercury. Other UV light sources that may be used in various embodiments include xenon arc lamps, deuterium arc lamps, mercury/xenon arc lamps, metal/halide arc lamps, and UV LEDs. The amount of light (power) from a UV LED is generally much lower than mercury or other discharge lamps, and therefore a plurality of LEDs may be included in various embodiments to destroy PFASs in a time frame of minutes to hours, for example.

Various embodiments include continuous reactors which provide a continuous flow of the PFAS solution through the reactor during UV treatment. Such continuous reactors may be hollow cylinders or tubes, with elongated lamp bulbs within transparent sleeves extending lengthwise through the length of the cylinders. An inlet may be located at or near one end, and an outlet may be located at or near the opposing end, with the lamps spaced to allow wastewater to flow between them, treating the water within range of the lamps as it passes the lamps. The continuous reactor system may provide equal continuous input and output flows entering and exiting the reactor or reactors, with a new supply of PFAS solution continuously flowing past the UV light sources during treatment, and without the need to pause the treatment process to evacuate and reload the reactor with a new batch of treatment solution.

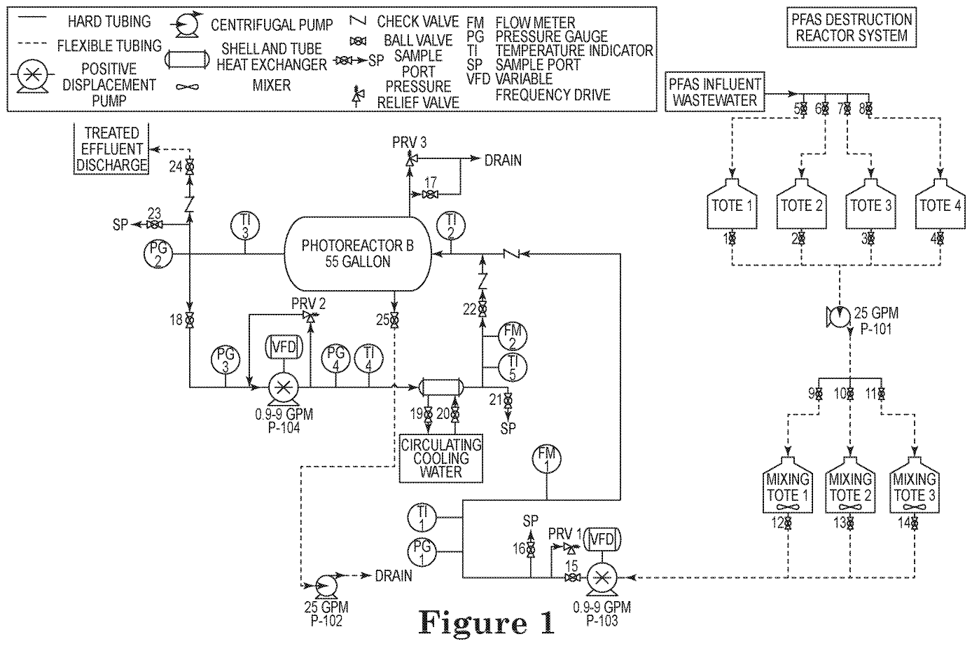

An example of a continuous flow reactor system which may be used in various embodiments is shown in FIG. 1. This figure shows a piping and instrumentation diagram for a PFAS destruction system using UV light and photosensitizers, but other configurations of piping and instrumentation could alternatively be used. In this example, the system includes two subsystems, a feed subsystem, and a treatment subsystem. In this example, the reactor can be operated in either batch mode, semi-continuous, and/or continuous mode. However, in alternative embodiments, the reactor may be capable of only continuous operation or only batch mode operation.

The feed subsystem includes a plurality of totes connected in parallel to a supply flow of wastewater influent, and a plurality of mixing totes downstream of the totes with the mixing totes also connected in parallel. In this example, there are four totes and three mixing totes, but other numbers of totes and/or mixing totes could alternatively be used in the system. Other systems may not include totes but may instead rely on a continuous fresh feed of wastewater from an upstream source where wastewater is generated, collected or treated.

Various pumps may be used to transfer the solution, such as a transfer centrifugal pump (P-101) and positive displacement (PD) pump (P-103). Transfer centrifugal pump transfers solution between the totes and the mixing totes, and positive displacement pump transfers solution between the mixing totes and the photoreactor. A variable frequency drive (VFD) is configured to control the flow rate. For example, the variable frequency drive may be set manually based on the flow meter's digital output.

The feed subsystem also includes a plurality of valves configured for isolation that allow for simultaneous filling of staging totes, transferring of mixing totes, and draining. The mixing tanks are equipped with mixers and used to introduce chemicals into the raw wastewater materials. The wastewater in each mixing tote may be validated for optimal pH and regular UV transmittance using pH and UV transmission sensor before being transferred to the reactor. Although not shown, the system may also include a plurality of supply tanks for chemicals which are added to the wastewater solution, such as photosensitizer, reductant, and base, in flow connection with the mixing totes through pipes which may be controlled by valves and pumps. The system may also include meters and sensors at various locations.

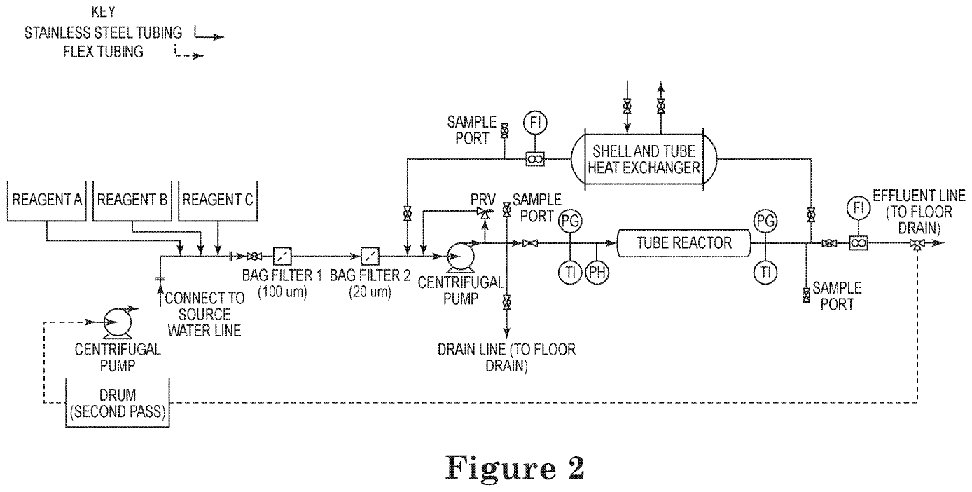

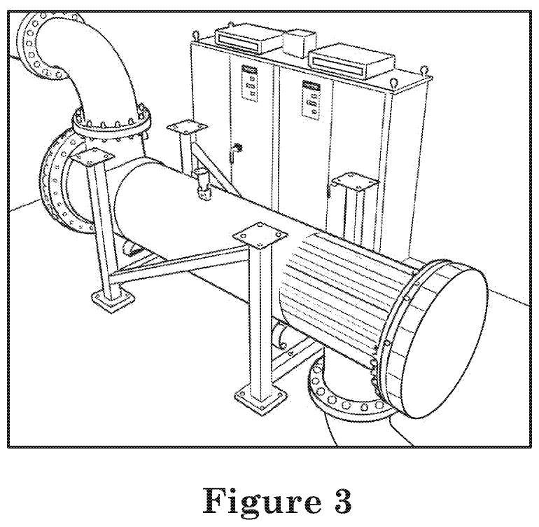

In the examples shown in FIGS. 1 and 2 (discussed further below), the reactor is a horizontal cylindrical pressure vessel; in other embodiments it may not be a pressure vessel. An example of a reactor which may be used as a basis for a photoreactor in various embodiments, after modification as described below, is shown in FIG. 3. The dimensions of the vessel may vary. In one example, the reactor vessel has an approximate length of 80 inches, such as between about 50 and about 120 inches, and an approximate diameter of about 18 inches, such as between about 12 and about 25 inches. In this example, the vessel contains about 50 low-pressure high-output UV lamps, such as 48 lamps, each with a nominal 150 W power lamp, with predominant emission of 254 nm wavelength. In another example, the reactor vessel has an approximate length of 80 inches, such as between about 50 and about 120 inches, and an approximate diameter of about 27 inches, such as between about 20 and about 35 inches. In this example, the vessel contains between 50 and 60 low-pressure high-output UV lamps, such as 55 lamps, each with a nominal 600 W power, with predominant emission of 254 nm wavelength. Other numbers of UV lamps may alternatively be used, such as between about 5 and about 100 lamps, or between about 30 and about 70 lamps. Furthermore, lamps having different nominal power may be used, such as between about 50 and about 1500 W, or between about 100 W and about 1200 W, or between about 150 W and about 800 W. In addition, all lamps may have the same predominant wavelength, such as 254 nm or 222 nm or other wavelengths, or 2 or more differing types of lamps may be used having differing predominant wavelengths. The lamps may be elongated and arranged throughout the vessel, as described further later in this disclosure.

The reactor includes an inlet at one end, and an outlet at the opposite end. Although the inlet and outlet are shown at the ends of the photoreactor in FIGS. 1 and 2, this is for illustrative purposes only. In various embodiments, the inlet and/or outlet may be located within the sidewalls of the photoreactor vessel, at or near the closed ends of the vessel, as shown in FIG. 3. For example, the flow of solution through the inlet may be in a direction approximately perpendicular to the longitudinal axis of the photoreactor, which is the general direction of solution flow through the photoreactor. The inlet may connect with an outer wall of the vessel on the top of the vessel, while the outlet may connect with the outer wall of the vessel on the bottom of the vessel, as shown in FIG. 3, though other configurations are also possible. However, unlike the reactor in FIG. 3, various embodiments may include inlets and outlets which are much smaller than those shown.

In the example shown in FIGS. 1 and 2, the reactor can be operated in either a batch mode or continuous mode, with untreated influent entering the reactor through the inlet and exiting the reactor through the outlet. In operation, the fluid may pass through the reactor only one time, or the fluid may circulate back through the reactor two or more times. Throughput rates may be set by an operator and may depend upon factors such as influent parameters including UV transmittance, level, type of background constituents present, and desired effluent properties.

In some embodiments, the system may optionally include a heat exchanger. For example, a heat exchanger may be included in systems which include a batch reactor, or a reactor capable of batch reactions, and may be particularly useful for long batch UV treatments to reduce heating of the UV light source. Systems including heat exchangers may circulate solution as needed to achieve sufficient cooling to maintain a desired temperature. The system may include temperature sensors, such as temperature monitoring indicators (TI2, TI3, TI4), which may be located upstream and/or downstream of the reactor, and which may be used to set the heat exchanger's cooling water flow rate.

When the reactor is operating in a batch mode, a pump such as PD pump (P-104) may be configured to push liquid through the UV reactor and heat exchanger, and the solution may circulate through the heat exchanger multiple times. For example, when the reactor is operated in batch mode, the feed subsystem may be configured to fill the photoreactor vessel with the solution containing PFAS and reagents using one or more pumps and valves, such as PD pump (P-103).

The system may also include a pressure relief system configured to isolate overflow, which may be controlled by a valve such as valve 17 in FIG. 1. The pressure relief system may prevent over pressure in the photoreactor in batch mode and in continuous mode.

The reactor may alternatively operate in a continuous mode. For example, the treatment subsystem may be configured such that the flow path of the solution does not pass through the optional heat exchange recirculation path (or the heat exchange recirculation path is omitted). Rather, the flow path of the solution may pass directly through the reactor to the effluent discharge or to post treatment systems or processes.

When the photoreactor is operating in continuous mode, or when the photoreactor is only configured for continuous treatment, the treatment subsystem may be configured to utilize the feed subsystem to provide a constant treatment solution supply at a rate which may be controlled by a user. For example, a pump, such as PD pump (P-103), may be configured to suction-lift liquid from a mixing tote across a range of flow rates through the reactor. In this example, the variable frequency drive (VFD) of the PD pump (P-103) may be used to control the solution flow rate. VFD is adjusted based on the flowmeter reading downstream of the pump. Once the pump is set, the VFD is left untouched unless a change in flow rates is desired.

The example system shown in FIG. 1 includes various components, including 4 staging totes, 3 mixing totes each with mixers, 2 centrifugal Pumps (P-101, P-102), 2 positive displacement pumps (P-103, P-104), a heat exchanger (HX), 5 digital temperature indicators (TI1, TI2, TI3, TI4, TI5), 4 analog pressure gauges (PG1, PG2, PG3, PG4), 2 digital flowmeter s(FM1, FM2), 2 variable frequency drives (VFD), 3 pressure relief valves (PRV-1, PRV-2, PRV-3), 25 ball valves (1, 2, 3, 4, 5, 6, 7, 8, 9, 10, 11, 12, 13, 14, 15, 16, 17, 18, 19, 20, 21, 22, 23, 24, 25), and 2 check valves. Other numbers and configurations of components could also be used, as well as additional or alternative components.

An alternative continuous UV photoreactor system is shown in FIG. 2, which does not include a feed subsystem. In this example, the wastewater flows continuously through influent tubing from a source such as a water line or other line providing continuous flow. Reagents may be provided to the wastewater within the influent tubing, such as from a plurality of reagent tanks such as tanks for Reagent A, Reagent B, and Reagent C. The reagent tanks may include one or more photosensitizer system reagents such as iodide and sulfite and a pH adjuster such as a base, for example. The system may include valves or injectors between the reagent tanks and the influent tubing to add the desired amount of each reagent into the influent tubing containing the wastewater to achieve the desired concentration of each reagent in the treatment solution. Heat exchangers and valves to vent gases can also be included between reactors. The reagents may mix with the wastewater as it travels through the influent tubing before entering the photoreactor, with additional mixing occurring as the combined wastewater and reagents pass through a pump such as the Centrifugal Pump shown in this example, with the pump optionally providing all of the mixing necessary and no additional mixing mechanism being required or included.

Before the wastewater passes into the photoreactor, it may pass through one or more filters in line with the influent tubing. For example, in the system shown in FIG. 2, the wastewater and reagents pass through Bag Filter 1 and Bag Filter 2, with progressively smaller mesh filtration at 100 micrometers and then 20 micrometers. In alternative embodiments, additional or fewer filters may be used, or the filters may be omitted, and different mesh sizes may be used. The choice of filters may depend upon the type of wastewater being treated and whether or not it has previously been filtered, for example. In addition, one or more of the filters could alternatively be located upstream of the reagent supply inlets in the tubing, rather than downstream as shown.

From the centrifugal pump, the wastewater passes into the photoreactor, identified as a tube reactor in this example. As in FIG. 1, the photoreactor in FIG. 2 is a tube reactor which may be operated in either batch mode or continuous mode, but in alternative embodiments the system could include a photoreactor which is exclusively a batch reactor or a continuous reactor. This system also includes an optional heat exchange system, with temperature sensors upstream and downstream of the photoreactor which may be used to control passage of wastewater through the heat exchanger. Some embodiments, such as tube reactors which are continuous reactors, may omit the heat exchanger system and may optionally include or omit one or both temperature sensors. Although not shown, the photoreactor may also include an overflow system as described above with regard to the photoreactor of FIG. 1.

After exiting the photoreactor, the wastewater may exit the system, such as through an effluent tubing line. Alternatively, if the wastewater is to be treated multiple times, it may recirculate back through recirculation tubing to a location upstream of the photoreactor. In the example shown in FIG. 2, the wastewater may circulate back to a storage tank such as the second pass storage drum. From there, it may be pumped back into influent tubing by a pump such as the centrifugal pump to reconnect with the influent tubing at a location such as a location upstream of the reagent inlets.

One example of a photoreactor which may be used in various embodiments is a UV reactor such as the Aquafine Avant 48, shown in FIG. 3, with modifications to allow PFAS destruction, which would not otherwise be successful with the existing reactor. For example, the reactor may be modified such that flow rates through the reactor are sufficiently low, and the flow is sufficiently turbulent, to allow high levels of PFAS destruction. For example, the inlet and outlet may be substantially narrowed. While the Aquafine Avant 48 includes 8 inch flange connections at the inlet and the outlet, when used as a photoreactor for PFAS destruction using the processes described herein, the inlet and outlet may be reduced in size to about 2 inches or less, such as between about 0.5 and about 2 inches, or between about 0.5 and about 1.5 inches, or between about 0.5 and about 1 inch, or about one inch or less, or about 0.75 inches. This may be done, for example, through the use of appropriately sized flanges, such as blind flanges, with the desired size connection, such as the sizes indicated above, such as about 0.75 inch FNPT connection, machined into the center of each. In addition, a pump may be added to the reactor, such as a boost pump connected to the inlet with piping such as stainless-steel tubing of a size to match the inlet, such as about 0.75 inches. Piping of a size to match the outlet, such as about 0.75 inches, may also be connected to the outlet.

Constricting the inlet and the outlet in this way may increase residence time and may avoid “channeling” of the solution through the reactor. UV light within the reactor may only penetrate a certain distance into the solution to be effective at destroying the PFAS, such that locations outside of this distance may be considered dead spaces. By constricting the inlet and the outlet in various embodiments, the flow velocity is increased, creating some mixing flow in the body of the reactor vessel and making the solution flow more turbulent. This may enable all portions of the water to have sufficient time within the active treatment distance from the UV light sources and prevent portions of the solution from flowing through the reactor only within these dead spaces or without sufficient time in treatment proximity to the UV light sources.

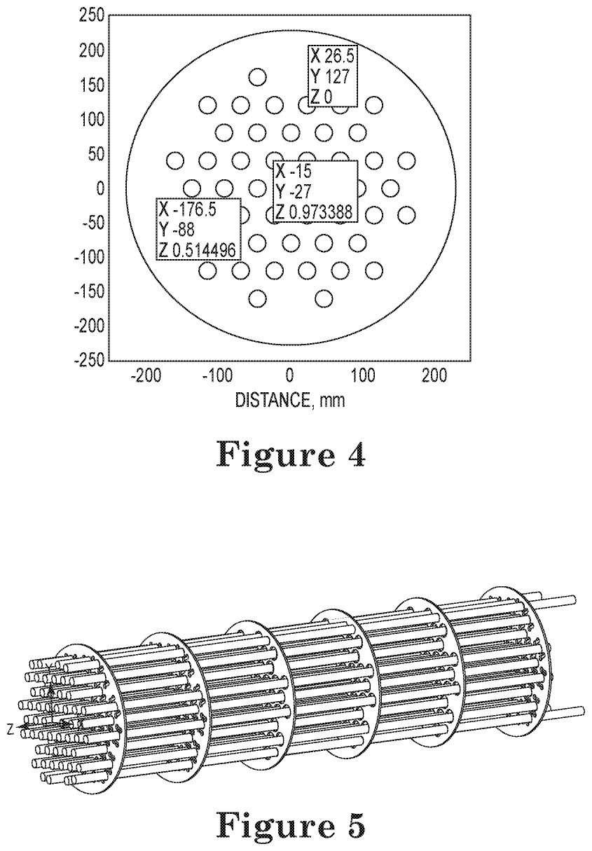

A cross-sectional representation of the UV light sources within a horizontal cylindrical photoreactor is shown in FIG. 4. Other spacing and configuration of the UV light sources may alternatively be used. The light sources are bulbs which are located within transparent sleeves, both of which are narrow and elongated and extend from one end of the vessel to the other, could optionally be arrayed in an evenly spaced side by side arrangement throughout the interior of the vessel. This spacing allows wastewater to flow between the sleeves containing the bulbs, at a distance and flowrate to allow for high levels of PFAS destruction. However, additional features of the vessel also cause wastewater flow to be turbulent, such that all water is in close enough proximity to the bulbs for a sufficient time for PFAS destruction without passing through the vessel untreated, such as within treatment dead spaces, with turbulent flow providing mixing such that wastewater does not pass through the vessel without sufficient time in the treatment zones around the lamps.

The turbulent flow may result from several factors in various examples. One factor which creates the more turbulent flow is the use of a substantially narrowed inlet, in combination with a sharp and rapid increase in cross section diameter as the wastewater enters the vessel. The rapid deceleration of flow upon entering the vessel may result in turbulence and recirculating flow. In addition, the wastewater enters the vessel in a direction perpendicular to the longitudinal axis, through which the wastewater travels, causing additional flow disruption. There are also elements within the vessel which act as baffles, further interrupting flow to create a more turbulent flow of wastewater through the vessel.

System volumes and flow rates for UV-based photoreactors are constrained by the characteristic reaction timescale and the physical dimensions of UV bulbs. These properties limit the ability to introduce mixing through increased fluid flow rates. It is also important to minimize the extent to which mixing systems absorb or otherwise block access of the fluid to UV light, which limits the ability to incorporate flow-directing plates oriented at any angle other than perpendicular to the reactor length.

Mixing systems that are useful for continuous-flow tubular UV photoreactors can include one or more internal baffles comprising plates, such as flat plates which may be metal, of the same size and shape as the interior reactor cross section, oriented approximately perpendicular to the direction of fluid flow and bearing perforations of a single shape and/or size or of various shapes and sizes. These perforations may provide the only passageway for the treatment solution to flow past the baffles and through the reactor vessel. The perforations cause fluid volumes to break apart into segmented volumes passing through each perforation. In various embodiments, some or all of the perforations may be intentionally misaligned in sequential baffles such that these segments can be preferentially directed along a nonlinear path. In various embodiments, fluid flow may also be accelerated as fluid volumes pass through baffle perforations, thereby increasing turbulent mixing in the vicinity of the baffles. In the latter case, fluid flow rate is increased by an amount that is inversely proportional to the fraction of the perforations to the total baffle area such that smaller and more widely spaced perforations increase fluid flow rates more and therefore increase turbulent mixing more. In various embodiments, perforations may also be fashioned in specific shapes or placed in specific locations along the baffle cross-section to redirect fluid flow. Finally, in various embodiments, the number and spacing of baffles may be manipulated to control the extent of fluid mixing. For UV photoreactors, containing lamps that are also elongated and oriented parallel to the flow direction, baffle plates may contain additional perforations as pass-throughs for bulbs; these perforations may allow mixing baffles to function as mechanical supports for elongated bulb assemblies without the passage or treatment solution, and/or they may also be intentionally oversized or fashioned into shapes to also accommodate fluid flow through these perforations. A UV photoreactor containing one or more mixing baffles to support UV bulbs and increase the proportion of fluid that traverses the reactor over a residence time exceeding the minimum time required to reach a target level of PFAS destruction. Mixing baffles may comprise flat plates with perforations positioned perpendicular to the direction of flow or transport of fluid through the photoreactor. The perforations in the mixing baffles may total an open area comprising between about 5% and about 80%, such as between about 7% and about 50% of the reactor cross sectional area. In some embodiments, the mixing baffles may have perforations that are circular and/or ovular in shape and 0.1-10 cm in diameter, such as 0.2-2 cm in diameter can be used. Ovular in shape refers to a shape that is a noncircular, elongated closed curve with no corners, like a stretched circle or an ellipse. Ovals may be symmetrical or unsymmetrical in various embodiments, and the diameters of the ovals may be measured in any direction. The quantity of mixing baffles may be at least one mixing baffle, such as between 1 and 3 mixing baffles, per unit of lineal length of the reactor that is equal to the reactor's diameter or equivalent linear dimension for a noncircular cross-section.

Various embodiments include a system of mixing baffles configured to maximizes the extent to which fluid volumes are mixed along the axial reactor dimension and minimizes the extent to which fluid volumes are mixed along the longitudinal dimension to enhance PFAS destruction through control over mixing. This approach has the effect of maximizing the proportion of treatment solution that spends greater than the minimum time in the reactor required to obtain a given level of PFAS destruction.

Other embodiments which enhance PFAS destruction through control over mixing include a system of mixing baffles configured to ensure each volume of fluid entering the reactor experiences equivalent total exposure to UV photons during the time spent in the reactor. In such embodiments, the sequence of mixing baffles may be configured such that fluid flow is driven faster in positions near the lamps and slower flow far from the lamps.

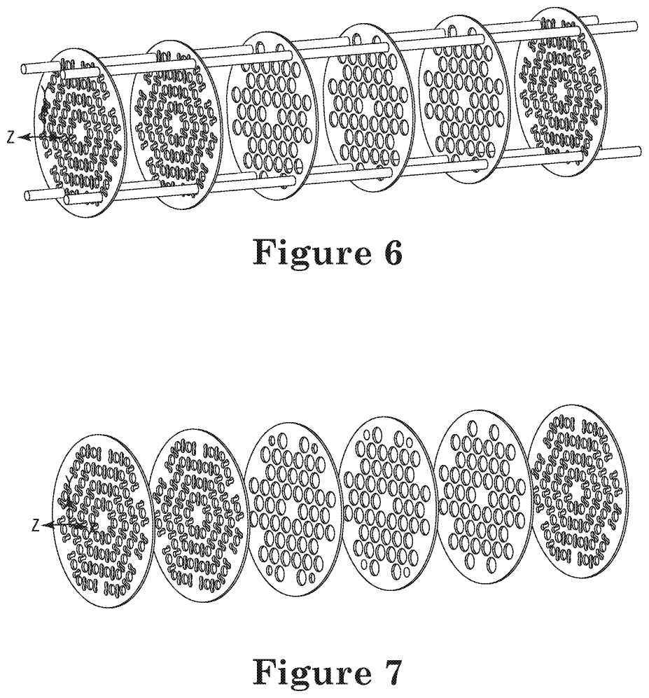

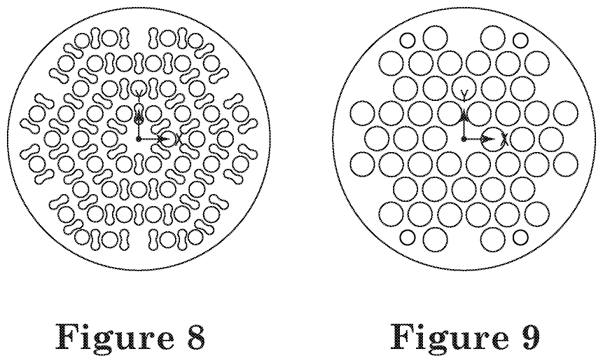

FIGS. 5-9 show a UV light support system or frame which is located within a tube photoreactor, such as those described herein. FIG. 5 shows a perspective view of the UV light support system which includes a plurality of perforated disks through which the lamp sleeves extend, as well as 4 support rods. In this example, there are 6 perforated disks, though there could alternatively be more or less. The perforated disks are rigid, thin, spaced apart, and coaxial. When positioned inside the tube reactor, the disks extend to the reactor walls, with the outer circumference abutting the inside surface of the reactor walls, such that wastewater must flow through the perforations under pressure from the pump in order to traverse the tube reactor. FIG. 6 shows the spaced plurality of perforated disks of FIG. 5, but without the lamps and only the support rods present, while FIG. 7 shows only the spaced plurality of disks, without the lamps or support rods present. In this example, there are two different configurations of perforated disks, such that the perforations are not in alignment throughout the flow path from one end of the reactor to the other. As such, wastewater must travel a circuitous path through the perforations, rather than a direct straight path. A perforated disk having a first configuration as shown in FIG. 8, in which the perforations include two types of apertures. A first array of apertures are circular apertures sized to closely accommodate the lamp sleeves in an abutting alignment. A second array of apertures which are oval with widened ends (cassinian ovals), are located between the circular apertures and provide a passage for the wastewater, though other aperture shapes, numbers and configurations could alternatively be used. The perforated disk having the second configuration as shown in FIG. 9 with an array of circular apertures, larger than the circular apertures in the first configuration shown in FIG. 8, and no oval apertures or other apertures to provide a pathway for the wastewater. Rather, in the perforated disks like those shown in FIG. 9, the lamp sleeves extend through the larger circular apertures with a gap between the outside of the sleeve wall and the inner edge of the apertures, allowing space for wastewater to flow through the aperture around the bulb sleeve. There is also a plurality of smaller apertures (in this example four, though other numbers such as three or five could be used), through which the support rods extend in abutting alignment with the disks to support and maintain the perforated disks in their positions and orientations. However, only the larger lamp sleeve circular apertures provide space for the passage for the wastewater through the disk, such that all of the wastewater that passes through the disks of the second configuration must pass in close proximity to the lamps. In this example, there are 48 circular apertures in each disk for the passage of the 48 lamps, though alternative embodiments could include more or fewer numbers of apertures and could have different arrangements. Likewise, the numbers and arrangements of the two types of perforated disks may vary from that shown in this example, and additional or fewer types of perforated disks may be used. However, whatever the arrangement of perforated disks, it can be appreciated that they act as baffles which create additional turbulence within the reactor, ensuring that the water flow is turbulent to maximize wastewater exposure to the ultraviolet light.

In some embodiments, continuous photoreactor systems like the one described above, or other photoreactor systems, such as those described herein or other systems, may be used to achieve very low levels of PFAS, with high levels of PFAS destruction, even when initial PFAS levels are very low. For example, PFAS levels may be reduced to zero or nearly zero, such as less than about 50 ppt, such as between zero and 50 ppt or between greater than zero such as 1 ppt and 50 ppt. These results may be achieved through the use of surprisingly low levels of photosensitizer system reagents, which was not previously recognized and is an unexpectedly effective process.

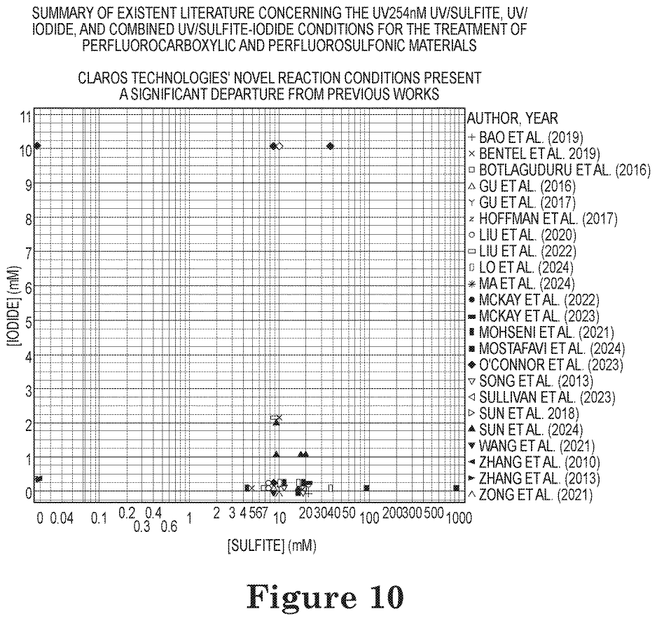

As shown in FIG. 10, references that teach the use of a combination of sulfite and iodide in UV treatment of PFAS teach the use of sulfite and iodide at higher levels. However, these levels have now been discovered to result in lower levels of PFAS destruction and less efficient PFAS destruction when PFAS levels are very low. FIG. 10 presents a summary of PFAS treatment with UV light and sulfite, UV light and iodide, and UV light and sulfite and iodide for the destruction of perfluorocarboxylic and perfluorosulfonic materials under UV 254 nm irradiation in the literature. In comparison, a superior level of PFAS destruction may be achieved through the use of lower levels of sulfite and iodide, demonstrating that the novel conditions described herein are significantly differentiated from other methods. FIG. 10 demonstrates that higher dosing schedules have been reported in the literature. A literature review consisting of greater than 20 publications concerning 254 nm UV treatment with sulfite, UV treatment with iodide and UV treatment sulfite and iodide for the degradation of perfluorocarboxylates and perfluorosulfonates is presented in FIG. 10, where the lower end of sulfite levels was observed at 10 mM for UV treatment with sulfite and iodide. In a stark departure from the novel conditions disclosed herein, recent literature supported that the use of significantly higher concentrations of sulfite, from 100 to 200 mM, was desirable to achieve better degradation kinetics. In UV treatment with sulfite and iodide systems, the concentration of the iodide spans from 1 mM to 10 mM. Meanwhile, in systems in the literature using UV treatment with iodide alone without sulfite, concentrations were between 0.25 and 10 mM, though the system performance with lower iodide dosing was far from satisfying (e.g., 4.4% defluorination of PFOA over 1.5 hours). Unlike UV treatment systems which used only iodide, the presence of sulfite in combination with iodide as used in various embodiments described herein results in a fundamentally different UV-based photoreduction processes. The optimized low levels of sulfite and iodide used in various embodiments for the treatment of very low levels of PFAS optimized provides a surprising and unpredictable improvement to the system's kinetic performance.

Various embodiments include systems and methods for destroying solutions PFAS including exposing a solution of PFAS containing a mixture of iodide and sulfite and at a pH of about 8 or more, or about 9 or more, or about 10 or more, or about 12 or higher to ultraviolet light from one or more bulbs. The levels of iodide and sulfite may be optimized, such as by addition or reduction of iodide and/or sulfite in the solution, such that greater than about 90 percent, or greater than about 95 percent, or greater than about 99 percent, or about 99.99 percent of the PFAS in the solution is destroyed. For example, the initial levels of PFAS in the solution may be between about zero or about 50 ppt and about 100 ppm or between about zero or about 50 ppt and about 10 ppm, or between about zero or about 50 ppt and about 5 ppm, or between about zero or about 50 ppt and about 2.5 ppm, or between about zero or about 50 ppt and about 500 ppb. The concentration of PFAS may be reduced to less than about lppm or about 100 ppb or about 100 ppt, or less than about 50 ppt, for example.

At very low levels of PFAS, the use of low levels of photosensitizer system reagents as additives may result in higher levels of PFAS destruction and less energy consumption than higher levels of photosensitizer system reagents. As such, the amount of photosensitizer system reagents added to the PFAS solution may be very low if the initial PFAS concentration is low. Alternatively, if the photosensitizer system reagents are already present in the solution, a portion or all of one or more or all of the reagents may be removed from the solution to reduce the levels of reagents when a sufficient amount of PFAS is destroyed such that the PFAS levels are very low. In embodiments in which all of one or more of the reagents is removed, the reagent may then be added back to the treatment solution to achieve a more precise desired concentration before UV treatment. In some embodiments, the initial PFAS containing solution may be a solution which was not previously treated for PFAS removal. In other embodiments, the initial PFAS solution may be a solution which was previously treated for PFAS removal, including methods of PFAS destruction using UV light and a photosensitizer system including iodide and sulfite or other photosensitizer system reagents, as well as other methods. These methods may have been performed separately or may have been performed immediately before the methods described herein, such as in a sequential manner. However, the previous treatment processes may have reduced the PFAS to very low levels, such as less than 500 ppb, or less than 1 ppm such as between about 500 ppb and 1 ppm, or less than 2.5 ppm such as between 500 ppb and 2.5 ppm. Alternatively, these levels may be the levels of PFAS present in the solution without prior treatment or reduction of the PFAS levels. In some embodiments, the destruction of PFAS may include two PFAS treatment steps. A first PFAS treatment step may be performed to lower the PFAS to less than about 12.5 ppm, or less than about 10 ppm, or less than about 5 ppm, or less than about 1 ppm, for example, such as by using a UV photoreactor, such as a UV photoreactor system or process described herein or other system. The first PFAS treatment step may include the use of photosensitizer system reagents that may include iodide, sulfite, and/or base, for example. In the photosensitizer system, generally the iodide may act as a photosensitizer while the sulfite may act as a sacrificial reductant to reactivate and maintain the effectiveness of the iodide. In some cases, however, such as a high sulfite concentrations, the sulfite may also act as a photosensitizer.

Up to two molar equivalents of sulfite are required per molar equivalent of carbon-fluoride bonds. Various embodiments address the challenge of constructing an appropriate dose of sulfite that balances the need to provide enough reductive equivalents (electrons) to the reaction, while at the same limiting its ability to serve as a primary sink for solvated electrons and to compete for light absorption with iodide.

Sulfite is an aggressive electron scavenger with a second order rate constant for electron scavenging equal to ~10⁶ L/mol/s. Generally, sulfite will compete for electrons at the same rate as PFAS (which have second order rate constants ~10⁸ L/mol/s) when its concentration is roughly two orders of magnitude greater than the concentration of PFAS initially present in the reactor. Additionally, sulfite is not an efficient light absorber compared to iodide (decadic molar extinction coefficient at 254 nm ϵ=56 L/mol/cm (sulfite) vs. 256 L/mol/cm (iodide)). Thus, as sulfite concentrations progress to values larger than 5 times that of iodide, it becomes the primary light absorber in the system. Therefore, in some embodiments, sulfite is present at concentrations less than 5 times that of iodide. This has implications for PFAS destruction because sulfite is an inferior generator of solvated electrons compared to iodide (free electron yield at 254 nm φ=0.117 vs. 0.186).

When sulfite is the primary electron scavenger in the system and/or when it reduces the electron generation capacity by overwhelming the absorption of iodide, PFAS destruction slows dramatically. Without a real time sensor for individual PFAS compounds, it may be impossible to know the exact concentration of PFAS in an influent such as an influent stream feeding a continuous reactor. Thus, to ensure there is enough sulfite for complete mineralization of influent PFAS, the concentration of sulfite may be overdose, such as in a first PFAS treatment step. For example, dosing super-stoichiometric sulfite in a single pass continuous or batch style reactor system may be used in various embodiments to ensure enough reducing equivalents are provided to ensure complete destruction. The larger the concentration of PFAS, the higher the super-stoichiometric dose must be, thereby causing increased reactor inefficiency. Thus, various embodiments may include an overdose of sulfite by some amount as a safety factor to ensure sulfite is not prematurely depleted in a in a first PFAS treatment step. As a result, PFAS destruction efficiency may decrease in a second PFAS treatment step, such as if sulfite levels are too high. Therefore, after the treatment solution exits the reactor from the first PFAS treatment step, the level of one or more of the reagents of the photosensitizer system in the treatment solution may be adjusted.

The amount and direction of adjustment of each photosensitizer system reagent following a first PFAS treatment step may depend upon how much of the reagent is present in the treatment solution after the first treatment step. For example, if all of the reagent was consumed during the first treatment step, additional reagents such as iodide or sulfite may be added to the treatment solution to achieve the desired low reagent levels as described herein. For example, the methods and systems may include metering low levels of sulfite and/or iodide into the treatment solution if the photosensitizer system reagent levels are too low. Alternatively, if excess photosensitizer system reagents remains in the treatment solution following the first treatment step, a portion of or all of one or more of the reagents may be removed from the treatment solution, again to achieve the desired low photosensitizer system reagent levels as described herein. For example, some or all of the iodide or sulfite may be removed. For example, air or oxygen may be added to the treatment solution to reduce or remove sulfite. The treatment solution may be passed through or contacted with an exchange media such as an anion exchange media or membrane to remove iodide. In some embodiments, the sulfite and/or the iodide may be electrochemically reduced, oxidized or adsorbed to reduce or remove it from the treatment solution. Alternatively, if the levels of photosensitizer system reagents in the treatment solution are sufficiently low after the first PFAS treatment step, no adjustment of reagent level may be needed, and this step may be omitted. Different methods may be used in various embodiments to lower the sulfite ion concentration, such as after a first UV treatment step as described herein or other similar methods. Various embodiments include chemical methods which may include the addition of air, oxygen, ozone, hypochlorite, and/or peroxide, photochemical or electrochemical methods to the treatment solution. The peroxides may be chosen from hydrogen peroxide, ter-butyl hydroperoxide, persulfate salt, or peroxyacetic acid, for example. Chemical oxidation may be facilitated by including a metal catalyst such as a transition metal ion such as, but not limited to, ferric or ferrous ions or other first row transition metal complexes. The methods and systems may include the use of a photoreactor that is a continuous flowing reactor wherein the rate of continuous flow influent into the reactor is equal to the rate of continuous flow of effluent out of the reactor during the photolysis process, such as the continuous flowing reactors described herein, or other reactors.

The treatment solution with the desired low levels of photosensitizer system reagents may then be treated during a second (or subsequent) PFAS treatment step. The actual low level of photosensitizer system reagents included in the solution may depend upon the level of PFAS present in the solution, as described further below and as shown in the Examples. Like the first PFAS treatment step, the second PFAS treatment step may be performed in a UV photoreactor like those described herein or in other UV photoreactors. In some embodiments, the first and second PFAS treatment steps may be performed in separate reactors, which may be the same or different, in a serial configuration. In other embodiments, they may be performed in the same reactor, with the treatment solution remaining in the reactor and adjustment of the photosensitizer system levels occurring within the reactor (if necessary), or with the treatment solution exiting the reactor and then cycling back through the reactor for a second treatment step. In still other embodiments, the systems and methods may include more than two PFAS treatment steps, such as three or more PFAS treatment steps, with adjustment of one or more of the photosensitizer system reagents between any or all of the PFAS treatment steps.

In various embodiments, the system may include a single reactor of multiple reactors, in which the multiple reactors may be configured to operate in series and/or in parallel. Embodiments which include multiple reactors configured to operate in parallel may accommodate higher flow rates, such as 100 s (such as 100 or 500 or more) or even 1000 s (such as 1000 or more or 2000 or more) of gallon per minute flow in combination.

In still other embodiments, the consumption of photosensitizer system reagents during a UV treatment process may be balanced by the destruction of the PFAS, such that as the PFAS levels fall to low levels, the photosensitizer system reagents likewise are consumed to achieve the desired low levels described herein. In such embodiments, a single PFAS treatment step may be used, with the desired levels of photosensitizer system reagents being achieved to match the PFAS levels during the treatment process such that the treatment process can continue with PFAS destruction from high levels to very low levels without interruption.

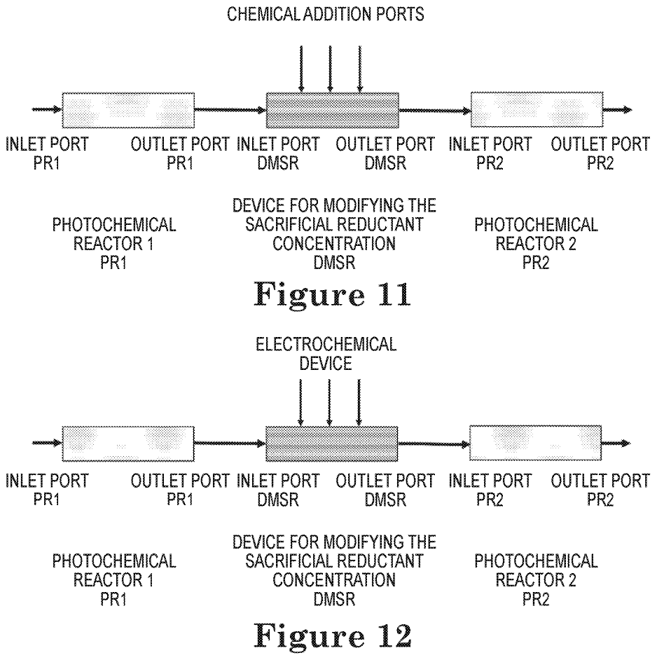

Schematics of various embodiments of PFAS treatment systems and methods include two PFAS treatment steps are shown in FIGS. 11-14. These figures show simplified schematic diagrams for a continuous system to partially or fully defluorinate PFAS. The system includes a first photochemical reactor, a device for modifying the concentration of the photosensitizer system reagent such as the sacrificial reductant concentration, and a second photochemical reactor. The photoreactor system is configured to provide a higher rate of partially or fully defluorination of PFAS. In this context PFAS refers to one or more PFAS molecules, and the above system results in partially or fully defluorination of at least one PFAS molecule. Although different chemistries can optionally be used to facilitate the destruction including both oxidative and reductive processes, the configuration as shown is especially effective in facilitating high rates of destruction using a reductive process such as an Advanced Reductive Process (ARP). In the advanced reductive process, a sacrificial reductant is used to regenerate the photochemically oxidized photosensitizer. However, the sacrificial reductant can also scavenge solvated electrons. As the photochemical reaction proceeds and the PFAS levels are lowered, it may be desirable to lower the sacrificial reductant concentration to achieve the lowest concentration of PFAS in the shortest amount of time. In various embodiments, an example of a photosensitizer and sacrificial reductant in an advanced reductive process is iodide as a photosensitizer and sulfite as a sacrificial reductant. In some embodiments, sulfite may be used as both the photosensitizer and the sacrificial reductant, with no other photosensitizer. Depending on the wavelength of UV light used to cause partial or full defluorination of PFAS, other inorganic anions such as chloride, bromide, and sulfate may be used as photosensitizer system reagents in various embodiments.

FIG. 11 provides an example of a continuous system for partially or fully defluorination of PFAS. An aqueous solution containing PFAS and photosensitizer system reagents enters into Inlet Port 1 of Photochemical Reactor 1 (PR1) wherein the solution is then subjected to irradiation by one or more UV lamps in PR1. The photochemically treated liquid exit Outlet Port 1 and the concentration of the original species are lower than when then when they entered Inlet Port 1. The PFAS is partially or fully defluorinated after treatment in Photochemical Reactor 1. Depending on the original PFAS concentration, between about 50% and about 99.99% of the PFAS may be partially or fully defluorination of PFAS. In some embodiments, about 50% to about 99.99% of the PFAS is converted to the fluoride ion (F⁻) and an oxidized carbon species such as carbonate (CO₃²⁻), oxalate (C₂O₄²⁻), formate (HCO₂⁻¹) or acetate (CH₃CO₂⁻).

The treatment solution then enters a device for modifying one or more of the photosensitizer system reagents such as the reductant, which may also be referred to as the sacrificial reductant. In the device, the concentration of the reagent, such as the sacrificial reductant, may be chemically oxidized by an oxidant to lower its concentration. The oxidant can be any chemical species capable of oxidizing the reagent, such as the sacrificial reductant. Examples of chemical oxidants which may be used in various embodiments include air, oxygen, ozone, or organic oxidants or inorganic oxidants such as peroxide or persulfate, for example, sodium persulfate. The oxidant can be added to the treatment solution through one or more chemical addition ports connected to the device. The treated solution then exits the device through the outlet port with a lowered reagent concentration, such as a lowered sulfite concentration. The treatment solution then enters Photochemical Reactor 2 through Inlet Port 2. The aqueous PFAS-containing solution is then irradiated in Photochemically Reactor 2 (PR2) where the reagent concentration such as the sulfite concentration has been reduced to optimize further PFAS for partial or full defluorination or mineralization. The aqueous fluid treated in PR2 then exits through Outlet Port 2. The resulting treated fluid may then be subjected to further PFAS treatment steps, with or without adjustment of photosensitizer system reagent levels, and/or post processing steps to remove any remaining PFAS or to reduce fluoride ion concentration, sulfate ion concentration, sulfite ion concentration from the effluent so the resulting solution can be discharged to the environment or recycled. In some embodiments, the residual PFAS may be further concentrated and retreated, such as using the methods and systems described herein.

FIG. 12 depicts a similar system as in FIG. 11, however, in this example, the device is an electrochemical device to lower the reagent such as the sacrificial reductant, sulfite. An example of an electrochemical process which may be used in various embodiments includes the oxidation of sulfite ion to sulfate ion. Such embodiments may optionally include the addition of reagents, such as additional electrolyte, reducing, or oxidizing reagents into the electrochemical device.

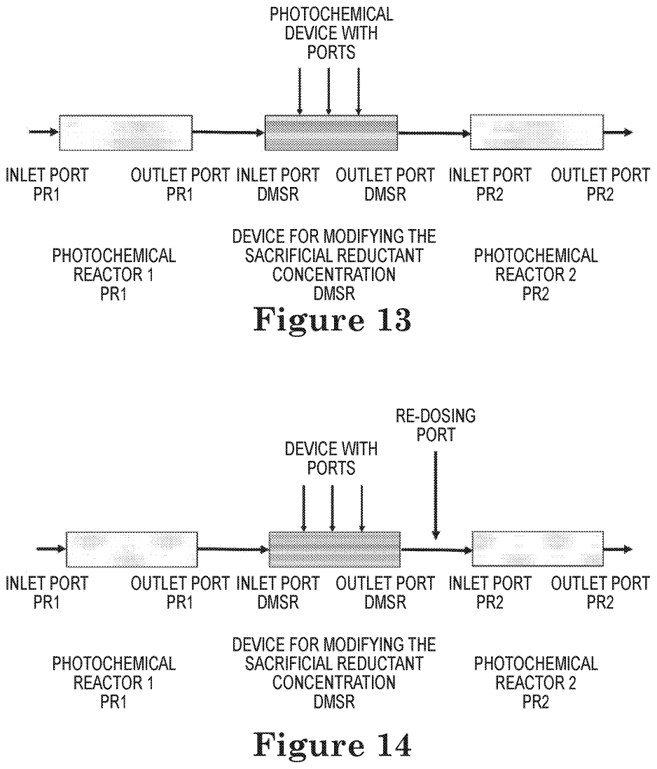

FIG. 13 depicts a similar system as in FIG. 12, however, in this example the treatment solution enters a device where chemical oxidants are added and the device also contains a UV lamp to accelerate the reagent oxidation such as the sulfite oxidation in addition to the electrochemical device to lower the sacrificial reductant. The chemical oxidants can be the same as in the description for the chemical oxidation described with regard to FIG. 11.

FIG. 14 depicts a similar system as in FIGS. 11-13, with an additional step of re-dosing the reagent such as the sacrificial reductant after lowering or removal by the device and before treatment Photochemical Reactor 2. Additionally, a redosing port may be located between the device and the next photochemical reactor to allow for redosing of chemicals such as but not limited to sacrificial reductants or photosensitizers. The re-dosing step may be necessary if all the reagent such as sacrificial reductant is completely or nearly completely removed, for example. In some examples, it may be easier to remove all the reagent such as the sacrificial reductant in the device and then add an optimal dose of the reagent such as the sacrificial reductant before the aqueous PFAS-containing solution enters PR 2. The re-dosing may involve adding as optimal amount of the sacrificial reductant and/or adding another reagent such as a base, like sodium hydroxide.

PFAS levels requiring the very low photosensitizer system reagent levels described herein may be referred to as the “initial” PFAS level or “initial” photosensitizer system reagents level. However, it should be understood that this initial level may include not only a starting PFAS level or photosensitizer system reagent level before treatment but also at the PFAS level or photosensitizer system reagent level at the start of any one of a series of PFAS treatment steps. Furthermore, the PFAS levels and the corresponding desired initial levels of photosensitizer system reagents also apply to PFAS levels and photosensitizer system reagent levels which occur during a PFAS treatment process, even if their initial levels were higher.

When discussing desired photosensitizer system reagent levels below and elsewhere herein, the PFAS solution is considered as having been free of oxygen. Wastewater may include varying levels of oxygen. Furthermore, oxygen removal may be achieved by various means. As such, the amount of a chemical or other material used for oxygen removal may vary. Therefore, it is useful to consider the photosensitizer system reagent levels required for PFAS treatment separately from removal of the oxygen. However, in some embodiments, sulfite may be used for the removal of oxygen, with the amount of sulfite dependent upon the oxygen levels present in the solution. In such embodiments, the sulfite levels provided below and elsewhere herein may be increased by the amount of sulfite required to remove the oxygen, such as between about 0.01 mM and about 1 mM, or between about 0.01 mM and about 0.75 mM, or between about 0.2 mM and about 0.5 mM, or between about 0.01 mM and about 0.25 mM sulfite.

In some embodiments, initial level of PFAS in the solution may be less than about 500 ppb, such as between about 100 and about 500 ppb, or between about 10 ppb and about 500 ppb, or between about 1 ppb and about 500 ppb. In such examples, the range of photosensitizer system reagents in the initial solution may be between about 0.1 mM and about 10.0 mM iodide and between about 0.0 or about 0.01 mM or about 0.1 mM and about 5.0 mM sulfite and may result in a destruction capacity equal to or greater than about 2 gpm (about 0.94 to 3.77 mg/min PFAS Destruction). In some such examples, the range of photosensitizer system reagents in the initial solution may be between about 0.1 mM and about 6.0 mM iodide and about 0.0 or about 0.01 mM or about 0.1 mM and about 4.5 mM sulfite and may result in destruction capacity equal to or greater than about 4 gpm. In some other such examples, the range of photosensitizer system reagents included in the initial solution may be between about 0.25 mM and about 3.0 mM iodide and between about 0.0 or about 0.01 mM or about 0.1 mM sulfite and about 1 mM sulfite and may result in destruction capacity equal to or greater than about 10 gpm. In still other such examples, the range of photosensitizer system reagents included in the initial solution may be between about 0.5 mM and about 2 mM iodide and between about 0.0 or about 0.01 mM or about 0.1 mM sulfite and about 0.2 mM sulfite, resulting in a destruction capacity equal to or greater than about 16 gpm.

In other examples, the initial concentration of PFAS in the solution may be between about 500 ppb and about 2500 ppb. In such examples, the range of photosensitizer system reagents in the initial solution may be between about 0.001 mM and about 10 mM iodide and between about 0.0 or about 0.01 mM and about 8.0 mM sulfite and may result in a destruction capacity equal to or greater than about 2 gpm. In other such examples, the range of photosensitizer system reagents in the initial solution may be between about 0.02 mM and about 10 mM iodide and between 0.0 mM or about 0.01 mM and about 5.0 mM sulfite and may result in a destruction capacity equal to or greater than about 4 gpm. In still other examples, the range of photosensitizer system reagents in the initial solution may be between about 0.02 and about 4.5 mM iodide and between about 0.0 or about 0.01 and about 2.5 mM sulfite and may result in a destruction capacity equal to or greater than about 5 gpm. In still other examples, the range of photosensitizer system reagents in the initial solution may be between about 0.001 and about 0.7 mM iodide and between about 0.0 or about 0.01 and about 0.3 mM sulfite and may result in a destruction capacity equal to or greater than about 16 gpm. In still other examples, the range of photosensitizer system reagents in the initial solution may be between about 0.10 and about 5 mM iodide and between about 0.0 or about 2.0 mM and about 5.0 mM sulfite and may result in a destruction capacity equal to or greater than about 60 gpm.

In other examples, the initial concentration of PFAS in the solution may be between about 500 ppb and around 12,500 ppb. In such examples, the range of photosensitizer system reagents in the initial solution may be between about 0.01 and about 1.0 mM iodide and between about 0.0 and 0.1 mM sulfite and may result in a destruction capacity is equal to or greater than about 20 gpm. In other such examples, the range of photosensitizer system reagents in the initial solution may be between about 0.01 and about 5.0 mM iodide and between about 0.0 or about 0.5 mM and about 5.0 mM sulfite and may result in a destruction capacity equal to or greater than about 10 gpm. In still other such embodiments, the range of photosensitizer system reagents may be between about 0.01 and about 10.0 mM Iodide and between about 0.0 or 0.01 and about 20.0 mM sulfite and may result in a destruction capacity is equal to or greater than about 10 gpm.

It should be understood that the gallons per minute which can be achieved may increase substantially depending upon the reactor system design. For example, the results described in the paragraphs above and elsewhere may be achieved using a photoreactor as described herein including 150 W bulbs. However, if the same or similar or other photoreactor system were modified to include higher power lights, for example, the destruction capacity in gallons per minute which may be achieved may be increased by an amount which is at least directly proportional to the increase in power. For example, the use of 300 W bulbs (doubling the power) may result in at least a doubling of the destruction capacity; the use of 600 W bulbs may result in at least a quadrupling of the destruction capacity, etc.

The methods and systems described herein achieve PFAS destruction to low levels very efficiently through the use of low levels of photosensitizer system reagents such as sulfite. For example, for initial PFAS concentrations between about 0 or about 100 ppt and about 2.5 ppm, the treatment solution may include sulfite in the range of about zero to about 0.1 mM and achieve PFAS destruction efficiency of above 2.5×10⁻³ gallons/min/watt. Alternatively, for the same initial PFAS concentration, the treatment solution may include between about 0.1 to about 1 mM sulfite and achieve PFAS destruction efficiency of 1.0×10⁻³ and 1.7×10⁻³ gallons/min/watt. In other alternatives, for the same initial PFAS concentration, the treatment solution may include between about 1 and about 3 mM sulfite and may achieve PFAS destruction efficiency of between about 0.75×10⁻³ and about 1.0×10⁻³ gallons/min/watt. In still other alternatives, for the same initial PFAS concentration, the treatment solution may include between about 3 and about 5 mM sulfite and achieve PFAS destruction efficiency of at least about 0.5 gallons/min/watt.

In other embodiments, for initial PFAS concentrations between about 2.5 and about 12.5 ppm, the treatment solution may include sulfite in the range of about 0.0 or about 0.001 and bout 0.1 mM to achieve a PFAS destruction efficiency of above 2.25×10⁻³ gallons/min/watt. In other embodiments, for the same initial PFAS concentration, the treatment solution may include sulfite in the range of about 0.1 to about 1 mM to achieve a PFAS destruction efficiency in gallons/min/watt is between about 1.0×10⁻³ and 2.25×10⁻³. In still other embodiments, for the same initial range of PFAS concentration, the treatment solution may include sulfite in the range of about 1 to about 3 mM to achieve a PFAS destruction efficiency in gallons/min/watt of between about 0.6×10⁻³ and 1.0×10⁻³. In still other embodiments, for the same initial range of PFAS concentration, the treatment solution may include sulfite in the range of about 3 to about 8 mM and may achieve a PFAS destruction efficiency of at least around 0.5 gallons/min/watt.

An effective system for photochemically destroying PFASs may include pretreatment, then photolysis, then post-treatment, then optionally a polishing step, for example. For example, various embodiments may include methods and systems for pretreatment including electrochemical pretreatment, nitrate pretreatment, filtration pretreatment, organics pretreatment, reagent pretreatment, metal complex pretreatment, solids pretreatment, and/or oxidative pretreatment. Various embodiments may also include methods and systems for combination photochemistry/electrochemistry, recycling photosensitizer system reagents, 185 nm hydroxyl radical generation, non-mobile media reduction of byproducts, oxygen reduction, and/or alternative solvents. Various embodiments may also include post-treatment steps such as iodine recovery, PFAS removal, fluoride ion removal, sulfate precipitation, and/or polishing steps.

Various embodiments may also include methods, systems and devices for recycling materials during PFAS destruction, as described in U.S. Pat. No. 12,473,222, entitled 18 Apr. 2024, and filed Jul. 12, 2024, which is hereby incorporated by reference. For example, various embodiments include methods of PFAS destruction including one or more of a) providing water containing PFAS to a reactor vessel, b) irradiating the water within the reactor vessel with UV light under conditions to destroy at least a portion of the PFAS to form treated water, c) passing the treated water through a selective membrane to form permeate and to form membrane reject comprising PFAS, d) providing the membrane reject back to the reactor vessel, e) providing additional water containing PFAS to the reactor vessel, wherein the membrane reject and the additional water containing PFAS are combined within the reactor vessel or before being provided to the reactor vessel, and f) irradiating the membrane reject and the additional water containing PFAS within the reactor vessel with UV light. The method may further include repeating the steps a plurality of times such that PFAS that is not destroyed is recycled through the reactor vessel. In some embodiments, the method also includes, before step b), adding a photosensitizer to the water containing PFAS. In some such embodiments, the membrane reject also includes the photosensitizer. In some such embodiments, the selective membrane may be a reverse osmosis or a nanofiltration membrane. For example, in some such embodiments, the selective membrane rejects at least about 99% of PFAS and photosensitizer. In some embodiments, the method also includes adding additional photosensitizer to the additional water containing PFAS or the membrane reject prior to step f). In various embodiments, the photosensitizer includes a halide salt such as iodide, for example. In some embodiments, the method also includes, prior to step d), removing sulfate from the membrane reject. For example, removing sulfate includes adding calcium to the membrane reject to form a sulfate precipitate and separating the sulfate precipitate from the membrane reject. In some embodiments, the method also includes, prior to step d, passing the membrane reject through a water softener to remove calcium, magnesium and/or iron. Any of these steps may be used in combination with the continuous reactor embodiments and the one and two or more step UV treatment processes and methods described herein, for example.

Different systems and methods may be employed for each of these steps, in various combinations, and may be used in combination with the methods and systems described herein. All of the steps may be used in some cases, while in other cases the system or methods may not include all of these steps. Furthermore, the systems and embodiments may further include means for fluid transportation including pipes, pumps, valves, inlets, outlets, etc., such as to connect various components and connect to and from inlets and outlets of various components.

### EXPERIMENTAL

### Example 1

In this example, small-scale photoreduction experiments on industrial wastewater were used to demonstrate that lower reagent concentrations are beneficial in improving the degradation kinetics of perfluoroalkyl carboxylate (PFCA) such as perfluorobutane carboxylate (PFBA, C₃F₉—COO⁻). The wastewater was effluent which included additives from the production of fluoromaterials (including PFBA) and which had been previously filtered using granular activated carbon (GAC).

100 mL of wastewater was transferred into each of five 100 mL quartz vials (QP062, Aireka Scientific Co., Ltd, HK). The wastewater was then mixed with sodium sulfite (Na₂SO₃) and potassium iodide (KI) at the following reaction conditions: 10 mM Na₂SO₃ and 10 mM KI, 10 mM Na₂SO₃ and 2 mM KI, 5 mM Na₂SO₃ and 2 mM KI, 2 mM Na₂SO₃ and 2 mM KI, and 1 mM Na₂SO₃ and 1 mM KI. For all the reaction conditions, 20 mM NaOH was added to each solution to reach a final pH of 12. Finally, the loaded solution was photolyzed in a UV254 nm photoreactor (LZC-ORG type, Luzchem Research Inc. Canada, equipped with eight 10-watt UV254 nm lamps). 3 mL samples were taken from the quartz vials at 0, 2.5, 5, 7.5, 10, and 15 minutes for LCMS quantification of PFBA. The results are presented in FIG. 10, which shows PFBA destruction percentage vs. time at the tested reagent dosing conditions.

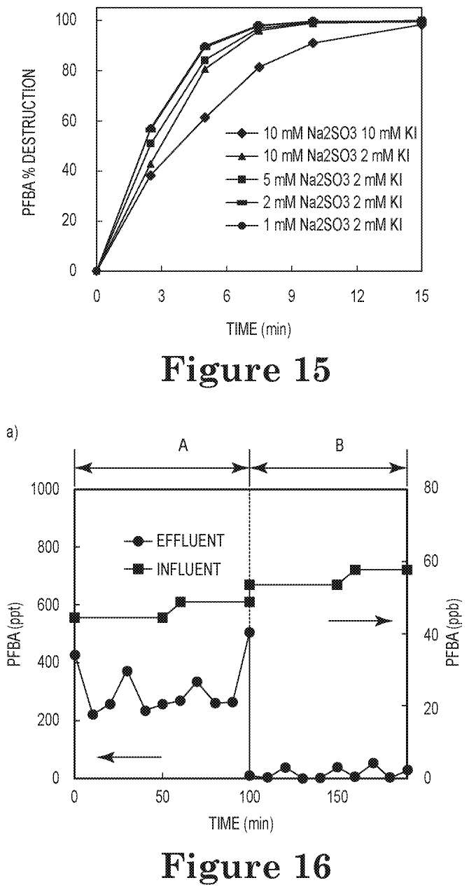

FIG. 15 shows PFBA destruction percentage at varied reagent dosing. Reagent concentrations for each data series are included in the plot. Destruction performance at 2 mM Na₂SO₃ and 2 mM KI conditions are nearly identical to 1 mM Na₂SO₃ and 2 mM KI and the data points overlapped on each other.

From FIG. 15, the lower reagent concentrations for UV254 nm photo-reduction resulted in faster kinetics and a higher destruction percentage. For instance, after 5 minutes photoreduction, 61% PFBA destruction was achieved at higher chemical dosing (e.g., 10 mM Na₂SO₃ and 10 mM KI). In contrast, when the photosensitizer system reagent concentration was reduced to 10 mM Na₂SO₃ and 2 mM KI, the PFBA destruction percentage increased to 81% after 5 minutes of photoreduction. With a further reduction of photosensitizer system reagents to 1 mM Na₂SO₃ and 2 mM KI, the PFBA destruction percentage increased to 90% after 5 minutes of photoreduction. Throughout the entire experiment, there was a general trend showing that the lower reagent concentration resulted in higher destruction percentage.

### Example 2

Photoreduction was performed on industrial wastewater at two different reagent concentrations using photoreactors in continuous mode. The wastewater was the same type of effluent as used in Example 1, but without GAC filtration. The photoreactors used in this example, referred to herein as the Continuous Flow Photoreactors, were Aquafine Avant 48 reactors, modified as described herein with 0.75 inch inlet and outlet ports. The results showed that lower reagent concentrations demonstrated a significantly higher PFBA percent destruction than the higher reagent concentrations.

In brief, 1200 L of wastewater in totes was mixed with two different concentrations of sodium sulfite (Na₂SO₃) and potassium iodide (KI) at two concentration levels: Condition A was the higher concentration level at 10 mM Na₂SO₃ and 5 mM KI, and Condition B was the lower concentration level at 1 mM Na₂SO₃ and 0.5 mM KI, demonstrating a 10× decrease in both reagent concentrations. In both conditions, 50% w/w NaOH solution was added to reach the final solution pH of 12. Finally, the loaded solution was photolyzed in the Continuous Flow Photoreactor at a continuous rate of 5 gallons per minute (GPM). 250 mL samples were taken from the reactor for Triple Quadrupole Mass Spectrometry (QQQ MS) analysis at varying time points. The results are presented in FIG. 16, which shows the influent and effluent PFBA concentrations vs. time at the two reagent dosing levels.

In FIG. 16, there is a difference in scale on the primary and secondary Y-axes. The influent PFBA concentration is plotted on the right gray Y-axis (in ppb), while the treated effluent PFBA concentration is plotted on the left black Y-axis (in ppt). The figure is separated by a vertical line in the middle, with results for condition A (10 mM Na₂SO₃, 5 mM KI) displayed on the left and condition B (1 mM Na₂SO₃, 0.5 mM KI) on the right.

As shown in FIG. 16, the lower reagent dosage (Condition B, 1 mM Na₂SO₃ and 0.5 mM KI) demonstrated better treatment performance and lower PFAS concentrations in treated effluent compared to the higher reagent dosage condition (Condition A, 10 mM Na₂SO₃, 5 mM KI). At the higher reagent dosage condition (Condition A, 10 mM Na₂SO₃, 5 mM KI), the effluent PFBA concentration averaged 309 ppt with an influent averaged 46.8 (44.6-49.0) ppb. At the lower reagent dosage condition (Condition B, 1 mM Na₂SO₃, 0.5 mM KI), the effluent PFBA concentration averaged 19.2 ppt with an influent averaged 55.7 (53.6-57.7) ppb, suggesting better kinetics at lower chemical reagent dosing.

### Example 3

In this example, the system's performance was tested at varied chemical dosing in a continuous operation mode at 5 gallons per minute through the Continuous Flow Photoreactor. At this flow rate, the continuous system demonstrated an average of 99.95% destruction of PFBA across four reaction conditions with approximately 20 hours of runtime and approximately 6000 gallons of industrial waste stream. The results also showed that the lowest reagent dosing resulted in the greatest destruction and lowest effluent PFBA concentration. The wastewater was the same type of effluent as used in the prior examples, including prior GAC filtration.

To prepare the influent waste stream for destruction, 1200 L of wastewater was added to a 1250 L tote and mixed with Na₂SO₃ and KI at four reagent dosing conditions listed in Table 1. The influent tote was then adjusted to pH 12 with 50% w/w NaOH.

TABLE 1
Reagent concentrations for each reaction condition A-D.

| | | |
|---|---|---|
| Reaction Conditions | Na₂SO₃ | KI |

| | | | | |
|---|---|---|---|---|
| A | 10 | mM | 2 | mM |
| B | 1 | mM | 2 | mM |
| C | 1 | mM | 1 | mM |
| D | 0.5 | mM | 0.5 | mM |

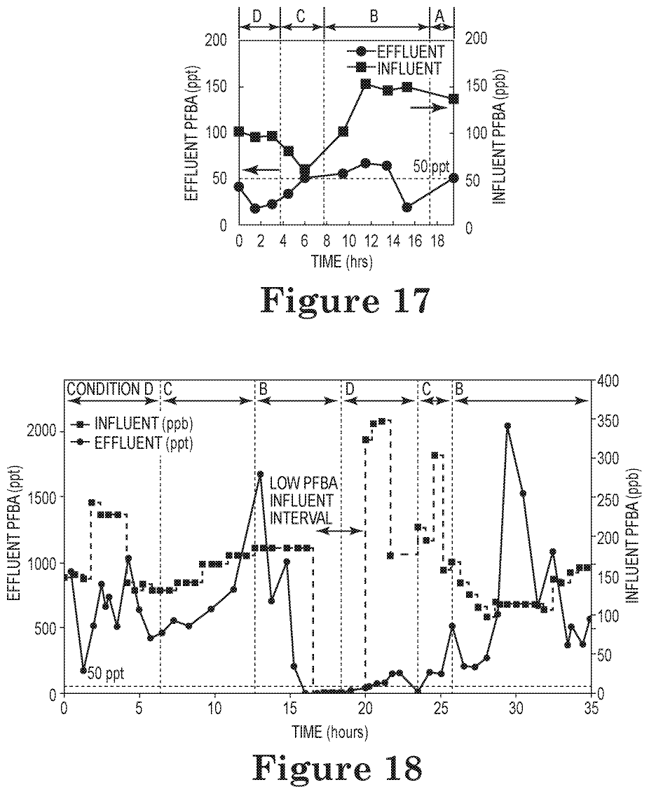

The results are shown in Table 2 and FIG. 17. FIG. 17 shows the influent and effluent PFBA concentrations at 5 GPM under the tested reaction conditions A-D. Note the scale on the right side of the graph (indicated in gray) is parts per billion (ppb) and the left side (indicated in black) is parts per trillion.

TABLE 2
Average influent and effluent concentrations of PFBA,
TFA, and 7H-Perfluoroheptanoic Acid at 5 GPM.

| PFAS | PFBA |
|---|---|
| Influent (ppb) | 59.3 − 105.9 |
| Effluent (ppb) | 0.042 ± 0.019 |
| Destruction Percentage (%) | 99.95 |

As shown in Table 2 and FIG. 17, the influent PFBA concentration ranged from 59.3-105.9 ppb, and the average effluent PFBA concentration was 42 ppt, demonstrating 99.95% destruction across all reaction conditions. FIG. 17 shows that the lowest reagent dosing, Condition D, resulted in the greatest destruction and lowest effluent PFBA concentration.

### Example 4

In this example, the performance was tested at varied chemical dosing in a continuous operation mode at 8.8 gallons per minute through the Continuous Flow Photoreactor. The influent wastewater was the same type as used in the previous examples, including prior GAC filtration. Three reaction conditions were tested over approximately 35 hours with a highly variable influent stream. Our continuous system consistently demonstrated greater than 99.7% destruction of PFBA during the most optimal reaction conditions. The three tested chemical conditions are listed as Table 3.

TABLE 3
Reagent concentrations for each reaction condition B-D.

| | | |
|---|---|---|
| Reaction Conditions | Na₂SO₃ | KI |

| | | | | |
|---|---|---|---|---|
| B | 1 | mM | 2 | mM |
| C | 1 | mM | 1 | mM |
| D | 0.5 | mM | 0.5 | mM |

The influent and effluent concentrations were measured periodically and are shown in Table 4 and FIG. 18. In FIG. 18, the influent and effluent PFBA concentrations for the wastewater are shown for a treatment flow rate of 8.8 GPM. The wastewater used in this example is the same type as used in the previous examples, including prior GAC filtration. The influent PFBA concentration (ppb) on the right axis and the effluent PFBA concentration (ppt) on the left axis are plotted against time (hours). Each section corresponds to a reagent dosing condition D, C, or B. The 50 ppt dashed line corresponds to the effluent axis and associated data. The PFBA influent was particularly low during one time period, which is annotated as “Low PFBA Influent Interval” from 16.5 to 20 hours on FIG. 18, and as B¹ in Table 4. Condition B in Table 4 does not include the results for the Low PFBA Influent Interval.

As shown in Table 4 and FIG. 18, the influent PFBA concentrations generally ranged from 96.8-303 ppb, and the average effluent PFBA concentration was about 400 ppt, demonstrating greater than 99.7% destruction for the two lowest reagent dosing conditions, C and D. During the Low PGBA Influent Interval, the influent PFBA concentration ranged from 0.3-0.7 ppb. On this day, an effluent PFBA concentration of less than 10 ppt was achieved, demonstrating greater than 99% destruction. These results demonstrate successful, greater than 99% destruction of the target compound PFBA at 8.8 GPM across influent waste streams with wide variability in PFBA concentration.

TABLE 4
Average influent and effluent concentration of PFBA at 8.8 GPM.

| Condition | Influent PFBA (ppb) | Effluent PFBA (ppb) |
|---|---|---|
| D | 131.6 − 150.4 | 0.438 ± 0.340 |
| C | 140.8 − 303 | 0.421 ± 0.257 |
| B | 96.8 − 185.2 | 0.752 ± 0.568 |
| B¹ | 0.3 − 0.7 | 0.005 ± 0.010 |

¹Low PFBA Influent Interval

### Example 5

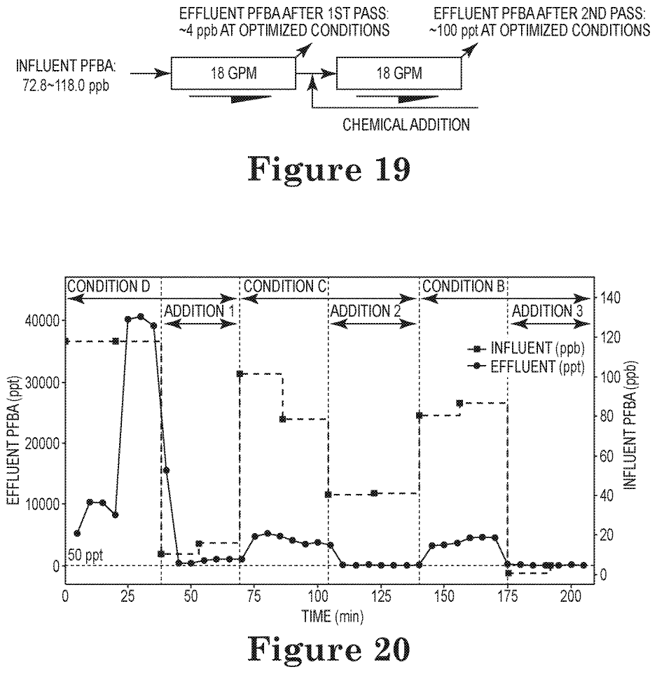

In this system, the continuous PFAS destruction system's performance was tested at varied chemical dosing in a continuous operation mode at 18 gallons per minute through the Continuous Flow Photoreactor with sequential treatment process. As shown in FIG. 19, we achieved 99.9% destruction of PFBA and produced an effluent concentration of approximately 100 ppt PFBA after the 2nd pass in the sequential treatment process. The wastewater was the same type as used in the above examples, including prior GAC filtration.

FIG. 20 shows a diagram of the 18 GPM sequential destruction process. As shown in FIG. 20, after the first pass through the continuous reactor at 18 GPM under three chemical dosage conditions, the treated effluent was collected, and additional reagents were added under varying chemical conditions, designated as Addition 1, Addition 2, and Addition 3 and shown in Table 5, below. The mixed solution was then treated again at 18 GPM using the continuous reactor. In this way, the reactor was used to simulate a treatment process using a series of two reactors with a second treatment between the two reactors.

TABLE 5
First pass reagent dosing conditions and
second pass reagent dosing additions.

| | First pass | | | | | Second pass | | |
|---|---|---|---|---|---|---|---|---|
| Conditions | Na₂SO₃ | | KI | | Additions | Na₂SO₃ | | KI |
| Condition B | 1 | mM | 2 | mM | Addition 3 | 2 | mM | 0 |
| Condition C | 1 | mM | 1 | mM | Addition 2 | 1 | mM | 0 |
| Condition D | 0.5 | mM | 0.5 | mM | Addition 1 | 0.5 | mM | 0 |

PFBA levels were tested in the influent and effluent streams at each condition and at various time points, and the results are shown in FIG. 20 and Table 6, below. In FIG. 20, the influent and effluent PFBA concentration is plotted against time (minutes). The PFBA concentration is shown in ppb in the gray series corresponding to the right axis. The effluent PFBA concentration is shown in ppt in the black series corresponding to the left axis. The 1st pass reagent dosing conditions are labelled as Condition D, C, and B, and the 2nd pass chemical additions are labeled as Addition 1, 2, and 3. Notably, the effluent from the first pass becomes the influent for the secondary addition pass, resulting in the fluctuations observed in the influent stream.

As shown in FIGS. 19 and 20 and Table 6, with an influent PFBA of 72.8-118.0 ppb, the effluent PFBA concentrations after the first pass averaged approximately 4 ppb under optimal reaction conditions B and C, demonstrating a PFBA destruction percentage of 95-97% after the first pass at 18 GPM. The effluent PFBA concentration was further reduced to approximately 100 ppt after the second pass under selected reaction conditions (e.g., Condition B+Addition 3 and Condition C+Addition 2). 99.9% PFBA destruction was achieved by the complete sequential destruction process at 18 GPM.

TABLE 6
Average PFBA concentrations (ppb) in the influent
stream and the effluent streams at each condition.

| | PFAS | | PFBA (ppb) |
|---|---|---|---|
| Influent | | | 72.8 − 118.0 |
| | Effluent | Condition B | 3.96 ± 0.63 |
| | | Condition B + Addition 3 | 0.11 ± 0.09 |
| | | Condition C | 4.20 ± 0.74 |
| | | Condition C + Addition 2 | 0.11 ± 0.05 |
| | | Condition D | 21.19 ± 15.88 |
| | | Condition D + Addition 1 | 0.81 ± 0.34 |

### Example 6

A kinetic mathematical reactor model has been constructed to predict the rate of PFAS destruction in a multi-lamp photo reactor. The critical inputs to the model are the reactor and lamp geometry, lamp power, efficiency and wavelength, chemical concentration of photosensitizer system reagents (in this case iodide and sulfite), pH, and the known second order rate constants for the reduction of PFAS compounds (adjusted to the reactor temperature in accordance with their Arrhenius dependent behavior), as well as the known second order rate constant for the reduction of iodine radical by sulfite.

For the data set generated in these examples, the model input 25 micro-molar molecular oxygen into each PFAS solution modeled. It then accounts for the reaction between oxygen and sulfite, in which these react to yield sulfate, such that 2SO₃²⁻+O₂ forms 2SO₄²⁻. The sulfite concentrations entered in the model are always greater than 2 times the dissolved oxygen concentration; thus, in all of the modeled runs the dissolved oxygen concentration is set to zero and the sulfite concentration is stoichiometrically reduced by the amount of dissolved oxygen initially present. This is the concentration of sulfite plotted, with all of the plots standing without alteration such that there is zero oxygen and a broad range of sulfite concentration with the minimum 0.001 mM.

In this example, the kinetic reactor model was used to simulate PFAS destruction in a solution comprising 400 ppb Perfluorobutanoic acid (PFBA), 20 ppb 7H-Perfluoroheptanoic Acid, and 2000 ppb Trifluoroacetic acid (TFA). The concentration dependence of the destruction was further adjusted by multiplying the concentration of this solution, C, by a scaling factor. For example, when a scaling factor of 0.1 is applied, i.e., 0.1×C, the solution comprised 40 ppb PFBA, 2 ppb 7H-Perfluoroheptanoic Acid, and 200 ppb TFA.

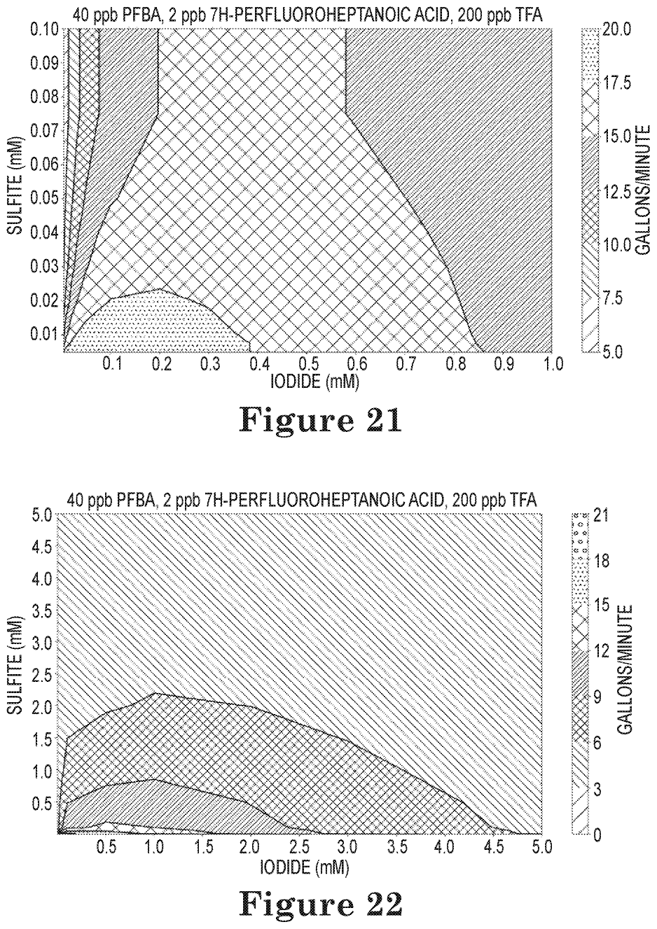

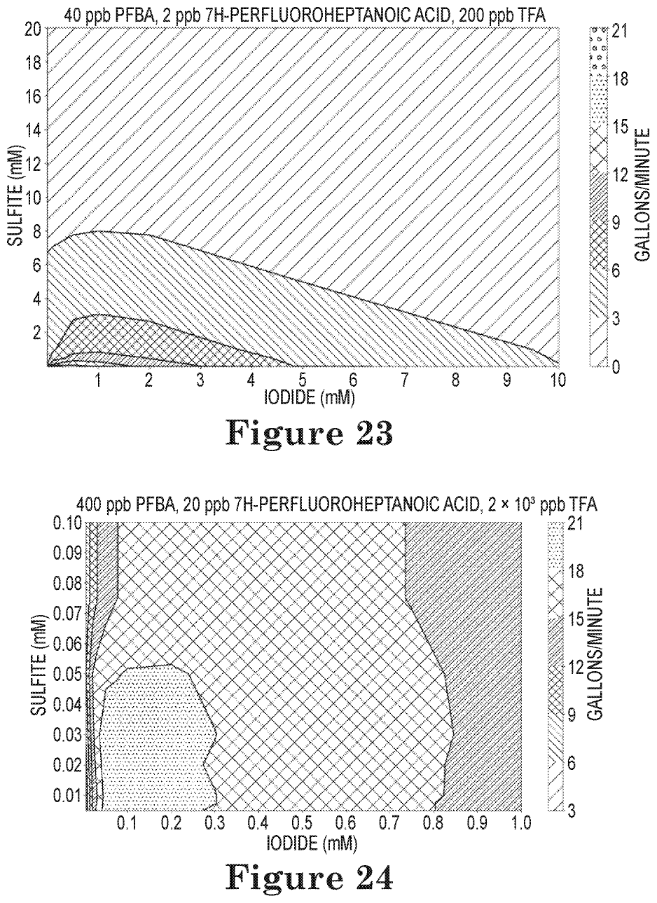

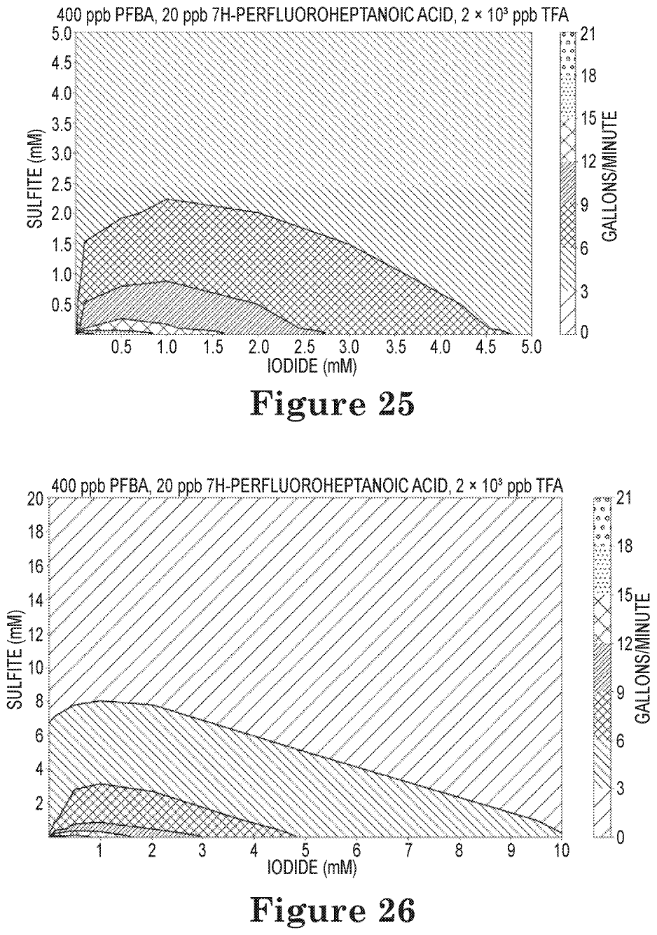

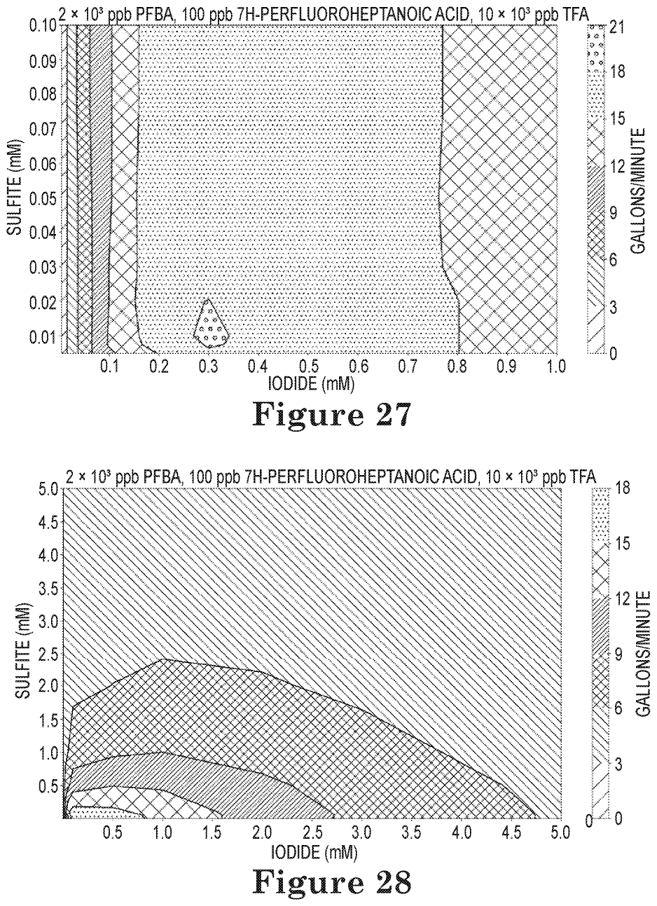

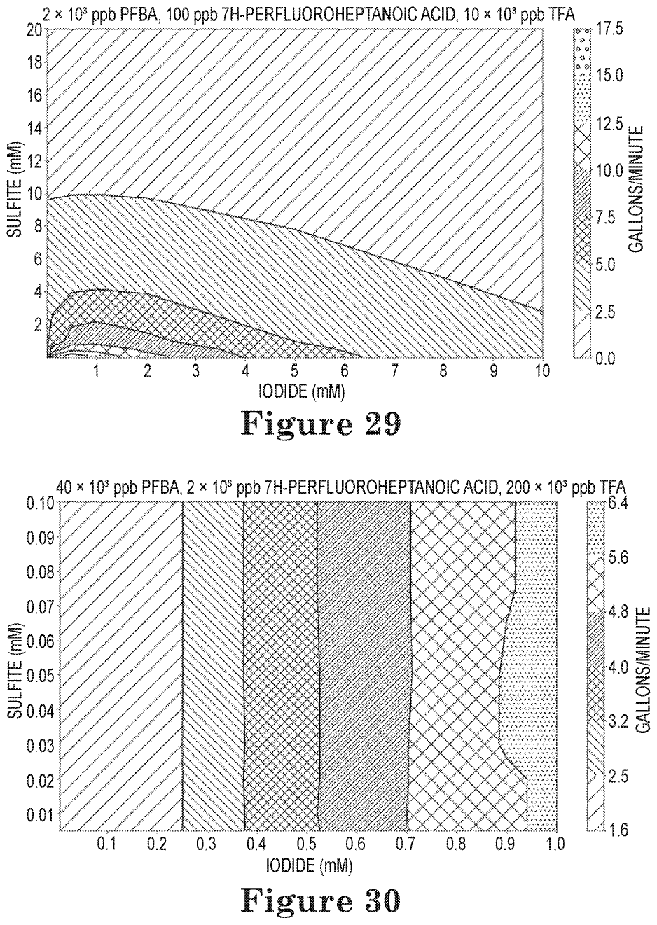

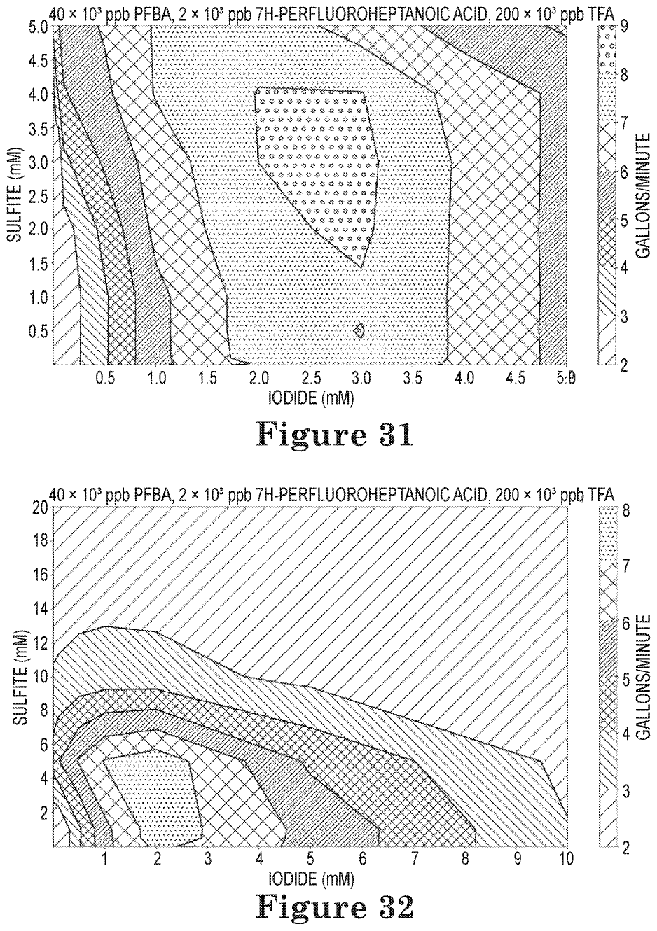

The kinetic reactor model was run using a matrix of sulfite and iodide concentrations at pH=12. The wavelength of the lamps in the reactor is 254 nm. Iodide ranged between 0.001 mM and 10 mM, and sulfite between 0.001 mM and 20 mM. The percent destruction of the parent PFAS compounds, i.e. the concentration weighted average of the destruction curves for each individual component, determined as a function of time, was recorded per each combination of sulfite and iodide. The reactor residence time required to destroy 99.99 percent (4 Log destruction) of the parent compounds was determined from the recorded data. The reactor liquid volume (in gallons) was divided by the residence time (in minutes) and the results are shown as contour plots for each scaled concentration (C) in FIGS. (21-32). FIGS. 21-27 detail PFAS destruction 0.1×C using an ever broadening range of photosensitizer system reagents per each concentration of PFAS solution. FIGS. 24-26, 27-29, and 30-32 show the same plots at 1×C, 5×C, and 100×C, respectively. The kinetic model calculations determine the residence time considering only well mixed batch (non-flowing) reactor. However, comparison of experiments to the kinetic reactor model demonstrates that the predicted residence times divided by the reactor capacity correlate with the maximum flow rate allowable to achieve a given percentage of destruction. Although 99.99 percent PFAS destruction was used in the model, other levels of PFAS destruction may be achieved such as about 80% or more, or about 90% or more, or about 95% or more, or about 99% or more, for example.

A description of the optimized photosensitizer system dose regime is provided in the caption of each figure. The plots demonstrate destruction in gallons per minute, gpm, (contoured regions) of PFAS solution as a function of sulfite concentration (y-axis), iodide concentration (x-axis).

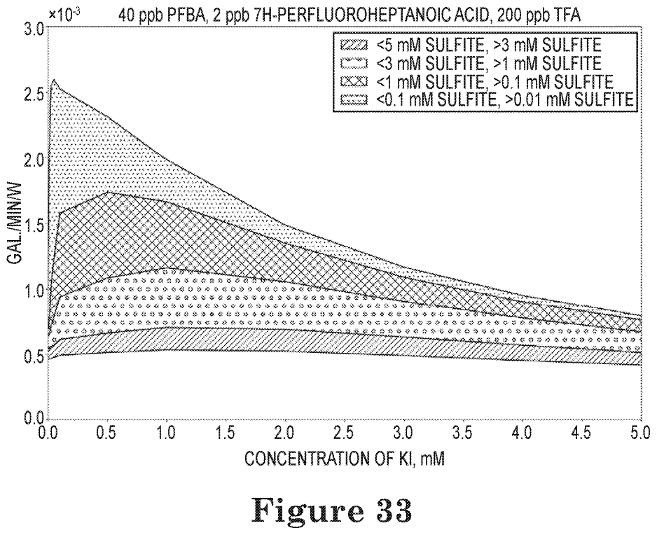

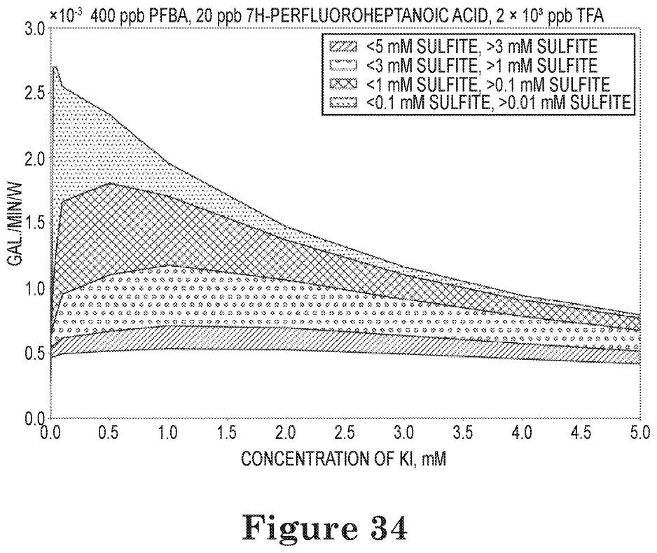

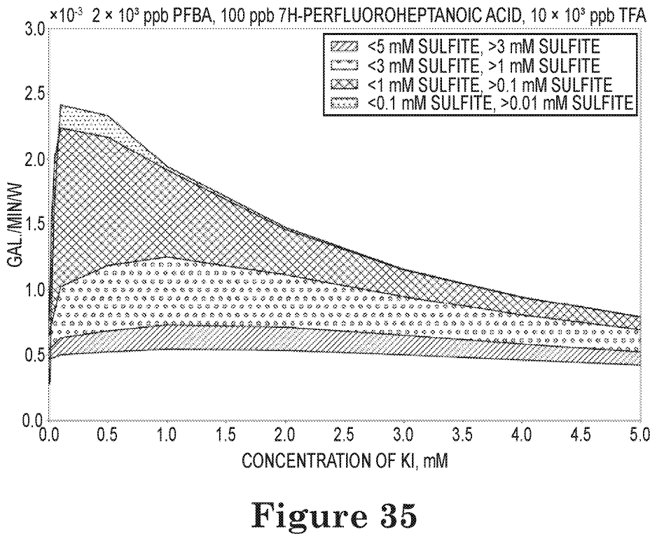

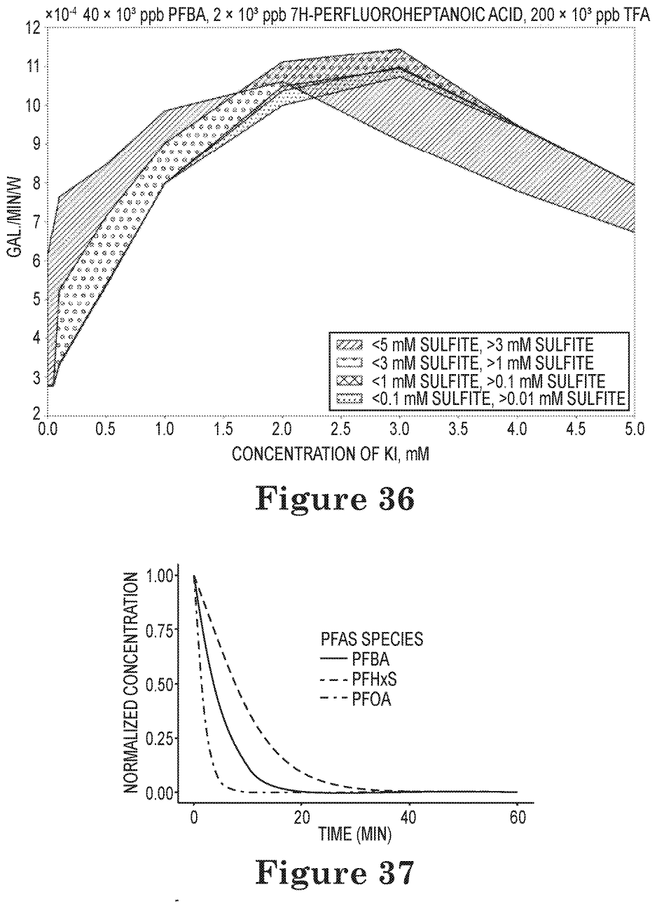

FIGS. 33-36 show destruction efficiency as a function of a range of sulfite concentrations for each of the PFAS mixtures shown in FIGS. 21-32 (0.1×C-100×C). The destruction is characterized by the power input per unit volume of PFAS solution per unit time, in this case gallons/min/Watt. These results show that for solutions below 2.5 ppm the destruction efficiency is much the same. However, at around 12.5 ppm, the destruction efficiency begins to taper off and falls below 2.5×10³ gal/min/Watt. Larger sulfite doses at this concentration provide the same efficiency as do smaller doses of sulfite for PFAS concentrations below 12.5 ppm for an equivalent dose of iodide (See FIGS. 33-35, cross-hatched region). In the range 250 ppm PFAS, the peak destruction efficiency is less than 10 times that for lower concentrations of PFAS (FIG. 35). Although in this case the total amount of PFAS destroyed is ~100 times that of the ~12.5 ppm solution (FIG. 35), destruction at the 4 log level yields a final PFAS concentration of 25 ppb, still three orders of magnitude above a targeted final PFAS concentration of 50 ppt.

### Example 7

The kinetic model in Example 6 was combined with a second mathematical model incorporating fluid dynamics to understand the impact of mixing on destruction. Modeling was carried out using commercial fluid dynamics simulation software (Ansys Fluent, Canonsburg, PA) that solves the coupled differential equations associated with momentum transfer in a set of discrete volume elements within a modeled reactor system.

FIG. 37 depicts the relationship between PFAS destruction and reaction time for 1 ppm (mass basis) of three representative PFAS compounds in a well-mixed batch reactor. This relationship was simulated using the same methods as in Example 6. It can be seen from FIG. 37 that any desired target destruction level would be expected to require a characteristic residence time. The details of this relationship depend on reagent concentration, light dose, and the reactivity of the PFAS molecule. For example, 99% destruction of perfluorobutanoic acid (PFBA) would be expected to require approximately 18 mins (1080 seconds) based on model results in FIG. 37.

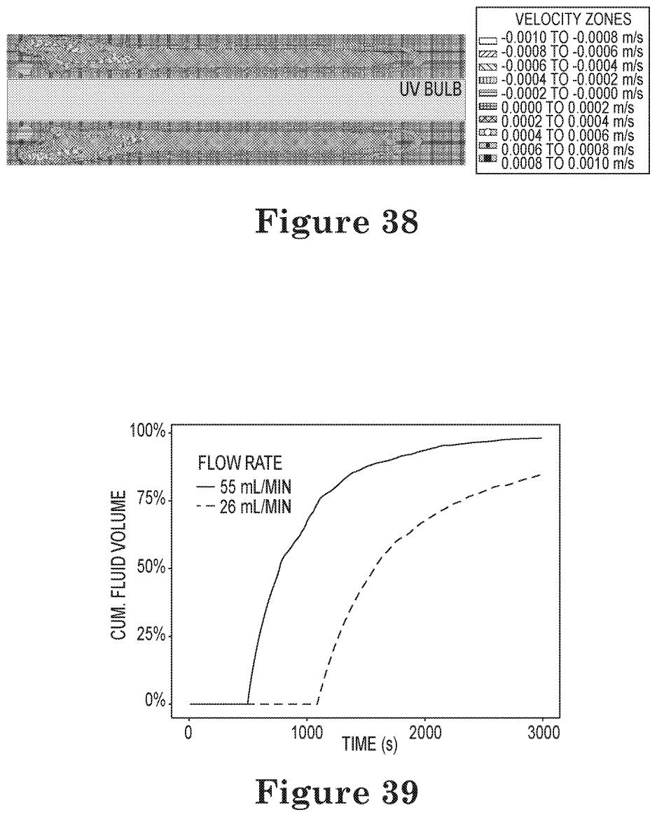

FIG. 38 schematizes the fluid dynamics associated with steady flow through a tube 25 cm in length with an inner diameter of 7.5 cm containing a single cylindrical UV254 nm bulb assembly with an outer diameter of 2.5 cm. This system configuration is comparable in dimensions to lab-scale reactors commonly used in UV-based photochemistry research. Steady flow through this reactor at a rate of 55 mL/min would translate to an average residence time of 18 mins, matching the model prediction in FIG. 37 for 99% destruction of PFBA. However, in practice the flow is heterogeneous across the cross-section of the reactor, with fluid residing in the central part of the annular region between the bulb assembly and the reactor wall flowing faster than fluid residing near the bulb assembly or the wall.

FIG. 39 depicts the corresponding probability function reflecting differing amounts of time that different portions of fluid spend within the reactor, also referred to as a cumulative residence time distribution, for the configuration in FIG. 38. It can be seen that, due to imperfect mixing in the tube, approximately 75% of the fluid spends less than 18 mins (1080 seconds) in the tubular reactor. Hence, the flow rate needs to be reduced by approximately 52% to 26 mL/min to ensure all the fluid spends at least 18 minutes in the reactor, thereby obtaining the target 99% destruction.

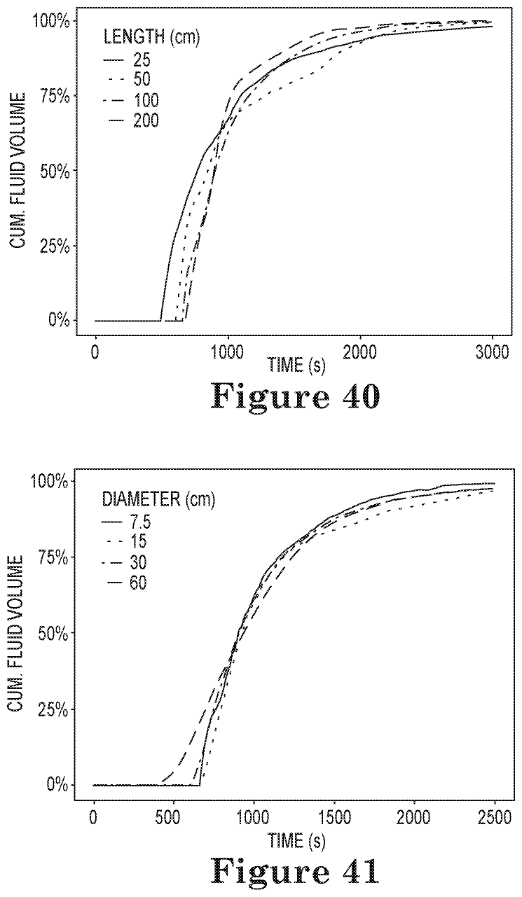

FIG. 40 depicts the residence time distribution for tubular reactor configurations matching the radial dimension in FIGS. 38 and 39 and progressively elongated along the z dimension to 50, 100, and 200 cm. Elongation in this fashion enables proportionally increased flow rates while maintaining a similar average residence time. It can be seen from FIG. 40 that the residence time distribution also narrows such that a greater proportion of the fluid spends at least 18 minutes in the reactor. This reflects improved mixing due to turbulence that develops with faster fluid flow. Hence, elongation in this fashion is one method of reactor scaleup that allows a UV destruction system to maintain PFAS destruction levels that are commensurate with model predictions based on assumptions of well-mixed behavior.

UV photoreactor systems cannot be elongated in this fashion indefinitely due to physical limitations associated with increased turbulence, system pressure, and mechanical integrity of reactor components, such as bulbs and lamp housings. Hence, FIG. 41 depicts residence time distributions based on fluid dynamics modeling for flow-through reactor systems that are 100 mm in length with progressively increasing inner diameter from 7.5 to 60 cm. These designs incorporate arrays of UV bulb fixtures to maintain similar overall optical power per unit volume. The modeled fluid flow rate was increased proportionally to the reactor cross sectional area (less the area occupied by bulbs) to maintain a nominal residence time of 18 mins.

It can be seen from FIG. 41 that increasing the reactor diameter from 7.5 to 15 cm initially sharpens the residence time distribution but further increases introduce significant flow inhomogeneities that reduce the proportion of fluid flow that spends at least 18 minutes in the reactor. Hence, scaleup in this fashion benefits significantly from incorporating additional internal reactor components that aid in mixing, such as turbulence-promoting baffles or static mixer systems. Moreover, the design of mixing promotors is further constrained by the need to minimize photon absorption by the mixing system itself.

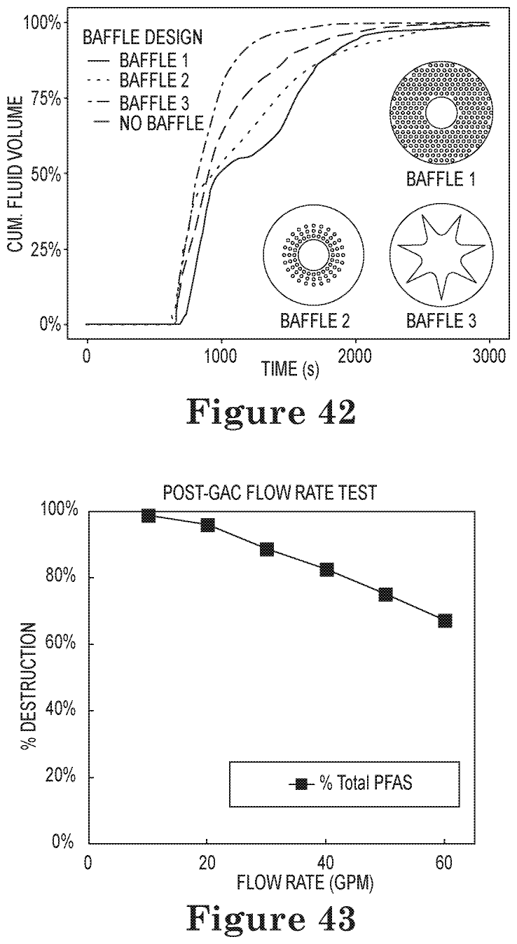

FIG. 42 depicts modeled residence time distributions for PFAS destruction systems without mixing baffles and with the baffle designs as annotated in the figure. It can be seen that some baffle designs facilitate improved mixing, which enables the reactor system to operate under fluid flow conditions that more closely match model predictions based on well-mixed systems. Other baffle designs introduce even greater inhomogeneities as regions of faster and slower fluid flow, which decrease overall reactor performance. These data illustrate that mixing baffles can benefit reactor performance, but only when they are designed appropriately.

### Example 8

A second continuous flow photoreactor with a modified design from the continuous flow photoreactor described in Examples 2 to 5 was used to destroy PFAS species in industrial wastewater over a range of flow rates. The second photoreactor was approximately 70 cm in inner diameter and 2 m in length, and it was further equipped with three internal mixing baffles and a set of UV bulbs accommodating approximately 30 kW of total input power. The second photoreactor was operated at flow rates of 10, 20, 30, 40, 50, and 60 gallons per minute (GPM) using the same photosensitizer level for effluent from the granular activated carbon (GAC) system (“post-GAC”). The influent total PFAS concentration was approximately 3 ppm (see Table 7). The destruction performance was evaluated based on targeted PFAS analysis using liquid chromatography-mass spectrometry (LC-MS).

FIG. 43 is a plot of Post-GAC Flow rate test results. As shown in FIG. 43, the second continuous flow photoreactor system maintained high accomplished PFAS destruction in the entire range of flow conditions tested. At a throughput of 10 GPM, total PFAS destruction was ~99%. When the flow rate was increased to 60 GPM, destruction efficiency remained at ~67%. Extrapolation of the relationship between PFAS destruction percentage and flow rate implies the second continuous flow photoreactor system would continue to destroy PFAS at flow rates exceeding 100 GPM. Flow rates up to 200 GPM, 300 GPM, 500 GPM, 700 GPM, and 1000 GPM can be achieved by increasing the scale of the reactors.

TABLE 7
Total PFAS Concentration in the Post-GAC Flow Rate Test

| Flowrate/GPM | 10 | 20 | 30 | 40 | 50 | 60 |
|---|---|---|---|---|---|---|
| Total PFAS/ppb | 3143 | 3107 | 3005 | 3050 | 2916 | 2846 |

### Example 9

A strategy to improve PFAS destruction at high PFAS concentrations, which, in a single pass reactor mandates the addition of large concentrations of sulfite, is to use a serial reactor system. Such a two-stage series reactor system, with a quench and re-dose of a lower amount of sulfite between the two series reactors, has been developed and tested, and the results are presented in this example. The system comprises a continuous flow two reactor series system in which the first reactor in the series is super-stoichiometrically dosed with sulfite, ensuring more than adequate sulfite for destruction. The parent compound and progeny are de-fluorinated to some extent in this first reactor. However, sulfite is in excess, and because of this as the PFAS concentration trends toward zero, the excess sulfite significantly inhibits the extent of the reaction. There will be some PFBA destruction in the first reactor; however, complete destruction of PFAS is not attainable because of the excess sulfite. Sulfite is quenched after the first reactor and re-dosed at a sub-stoichiometric amount relative to the initial PFAS level and respective progeny that remain, before entering the second reactor. Enhancement of destruction of the parent compound and all progenies are observed relative to the same system in which the sulfite was not re-dosed. Modeling and experimental details follow.

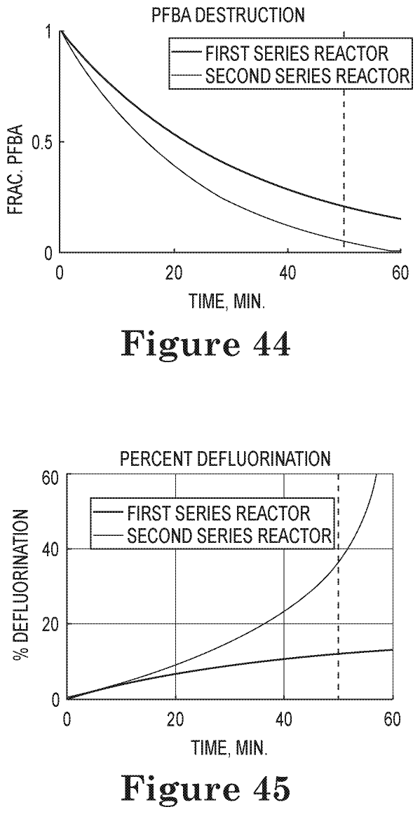

Kinetic mathematical reactor models indicate that the rate of PFAS destruction, for both the parent compound and progeny, is depressed when the sulfite concentration exceeds that necessary for exact stoichiometric mineralization of a given PFAS compound, i.e a super-stoichiometric dose. Further, kinetic reactor modeling predicts that at sub-stoichiometric concentrations of sulfites, rates will exceed those of stoichiometric addition. A kinetic mathematical reactor model system was used to predict destruction of 250 ppm (1.17 mM) PFBA solution in the two-stage reactor system. Plots of the parent compound destruction and de-fluorination of the progeny species are shown in FIGS. 44 and 45. At 250 ppm PFBA, the concentration is well into the level that can be considered “High”. With 7 equivalents of fluorine per every one PFBA, and an upper bound of 2 equivalents of sulfite per fluorine equivalent, up to 15 mM sulfite is needed for complete mineralization. This is the maximum amount needed, in one single reactor pass, to destroy all PFBA parent molecules and all progeny. The 15 mM sulfite is well above 5 times the 0.5 mM iodide used, and close to 15 times the amount of PFAS present. The pH was set to 12 in the model (20 mM NaOH). The model was run sequentially, initially with 250 ppm PFBA, 20 mM sulfite, at pH 12. This is the influent of the first stage reactor. At these concentrations of reagents and PFAS, 80% destruction of the parent compound, and 15% destruction of the progeny are predicted to occur within 50 minutes. Fifty minutes is significant because it is the residence time of a solution flowing through the 750 ml reactor at a rate of 15 mL/minute. The concentration of parent and progeny species are fixed at their respective values after the first reactor and used as the influent concentrations for the second stage reactor. After the second stage, de-fluorination is nearly 35% and the destruction of the parent compound is 98%.

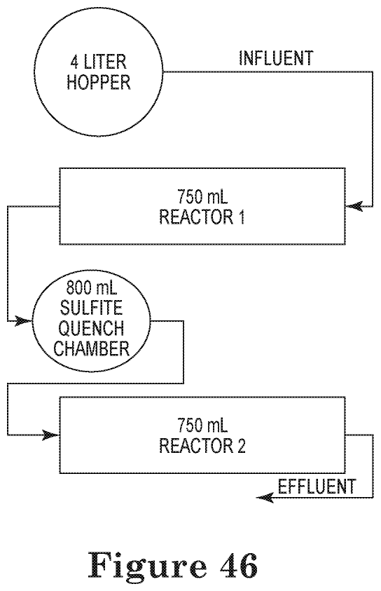

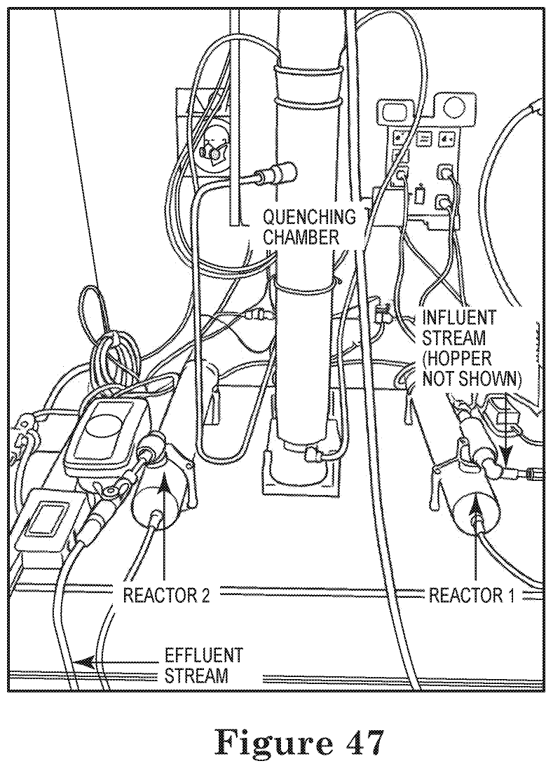

A schematic of such a reactor system is shown in FIG. 46. Gravitationally fed PFBA solution influent flows from an elevated 4000 mL hopper into a 750 mL first reactor equipped with a 16-Watt 254 nm lamp immersed in the solution and centrally positioned along the long axis of the reactor. The influent is super-stoichiometrically dosed with sulfite. Partially defluorinated effluent flows from the first reactor into a sulfite quenching chamber, in which the solution is mixed with air (containing approximately 21% oxygen) under UV 254 nm light exposure. The oxygen in the air serves as an oxidant and in combination with 254 nm photons from a 60-Watt, 254 nm bulb, oxidizes sulfite to sulfate. The bulb is positioned in a quartz sleeve, and the lamp is positioned centrally along the vertical axis of the sulfite quenching chamber. The solution volume of the sulfite quenching chamber is 800 mL. Between the sulfite quenching chamber and the second reactor, sulfite is re-dosed using an injection pump. The capacity of the second reactor is 750 ml, and the lamp electrical power is 16 W. Lamp placement and type is identical to that of the first. Lamp information is shown in Table 8. All flexible tubing in the reactor system is ⅛″ ID Tygon. All tubing connecting the reactors is ¼″ GD 316 Stainless. A photograph of the series reactor system is shown in FIG. 47.

TABLE 8
Lamp and Sleeve Information

| | | | Surface | | | |
|---|---|---|---|---|---|---|
| | | | irradiance | | | |
| | Lamp | | at lamp | | | |
| | Power | Lamp | sleeve, | Lamp Sleeve | | |
| | (Watts) | Efficiency | mW/cm2 | Diameter | | Lamp Manufacturer |
| Reactor 1 | 16 | 0.3 | 25.7 | 2.3 | cm | Realgoal |
| | | | | | | http://www.china-realgoal.com/view.asp ?id=145 |
| Sulfite | 60 | 0.25 | 18.9 | 5.0 | cm | UV-Technik |
| Quench | | | | | | |
| Chamber | | | | | | |
| Reactor 2 | 16 | 0.3 | 25.7 | 2.3 | cm | Realgoal |

http://www.china-realgoal.com/view.asp ?id=145

In the experiment, the two-reactor system shown in FIG. 47 was flushed with 6 liters of water, then 3 liters of the PFBA solution prior to the beginning of the experiment. The influent solution comprised 250 ppm PFBA, 20 mM sulfite, 0.5 mM iodide, and 20 mM NaOH. Details of chemical composition, grade, and manufacturer are found in Table 9.

TABLE 9

| Chemical | Manufacturer | Grade |
|---|---|---|
| Sodium Hydroxide, | Sigma Aldrich | Reagent |
| NaOH | | |
| Sodium Sulfate, Na2SO3 | Cessec USA | Technical |
| Potassium Iodide, KOH | Deepwater | Technical |
| | Chemicals, Inc | |
| PFBA | Sigma Aldrich | Research 98% |

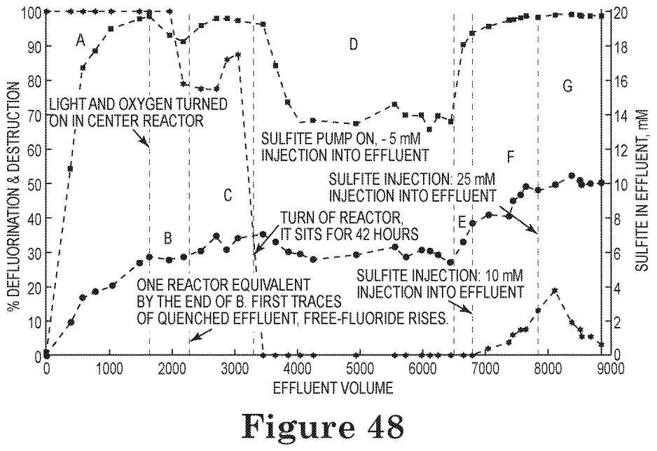

The solution flowed at a constant flow rate of 15 mL per minute throughout the experiment. Initially, only the first and second reactor UV254 lamps were turned on, the lamp in the quenching reactor was off, as was the air pump. The effluent emerging from the third stage of the reactor was collected and analyzed by ISE (Ion Selective Electrode analysis) to determine free-fluoride production, and LCMS was used to determine PFBA destruction. The flow of the solution through the reactor, and results, plotted in detail in FIG. 48 (capital letters shown below reference regions of the figure). FIG. 48 depicts the relationship between cumulative volume traversing the reactor assembly and percent de-fluorination (black filled circles); percent PFBA parent compound destruction (black stars); and sulfite concentration (mM) (grey squares). Results are summarized as follows:

A. Between 0- and 1750-ml cumulative flow, UV254 lamps in the first and second sequential reactors are on. The lamp and air pump feeding the sulfite quenching hopper are off. During this period of flow, PFBA destruction and de-fluorination are building.

B. At 1750 ml total effluent, the lamp and air pump in the quenching reactor are turned on. In this flow region, sulfite is quenched in the center vertical tank. At the end of this flow region, 2300 ml (at least one complete reactor system), has flowed through the reactor system, and it is in this region free-fluoride release begins to stabilize and decrease at a rate less than that of region A.

C. Measured sulfite concentrations begin to drop slightly as the effluent from the quenching hopper has now made its way through the quenching hopper. Parent compound destruction stays more or less stable with some slight inconsistency at 2200-2300 ml total effluent. Free fluoride continues to increase and by 3300 mL effluent has reached 35%. Destruction up until the end of this region can be attributed to destruction in the two-stage reactor system with an initial 20 mM dose of sulfite with no effect of quenching and re-dosing sulfite. The sulfite concentration is dropping here, but only to levels that are 3-4 mM which is predicted by modeling to have a very small effect on PFBA destruction.

D. In this flow region, the free fluoride evolution drops but stays consistent in the latter half of the region at 29%, a value slightly more than that predicted my model for destruction in the first reactor, but less than that predicted for both. The fluoride evolution and destruction in this region are the result of de-fluorination and destruction in the first reactor, as well as some possible destruction and fluorination in the quenching hopper. The quenching hopper has all the components of a photochemical reactor capable of PFAS destruction. However, the persistent level of oxygen in this chamber will result in extreme solvated electron quenching and limit defluorination.

E. Sulfite injection begins between the quenching chamber and the second reactor at the beginning of this flow region. The rate of sulfite dosing gradually increased to a rate at which a steady 5 mM concentration is maintained. Effluent free fluoride begins to rapidly rise, as does parent compound destruction, in this region.

F. At the beginning of the flow region, sulfite dosing increases to maintain the concentration at 10 mM. Free fluoride concentration continues to increase, and parent compound destruction increases as well.

G. The effects of the 10 mM sulfite dosing are felt to full effect. Free fluoride has increased to 50% and destruction has reached its maximum. By the end of this flow region, free fluoride release is a full 16% more than it was with only a 20 mM initial dose in the influent (end of region C), demonstrating enhanced PFBA destruction as the result of a more optimal sulfite dosing regimen. The parent compound destruction has reached levels above 99%.

As used herein, the terms “substantially” or “generally” refer to the complete or near complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may, in some cases, depend on the specific context. However, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is no significant effect thereof.

In the foregoing description, the inventions have been described with reference to specific embodiments. However, it may be understood that various modifications and changes may be made without departing from the scope of the inventions.

1. A method of lowering a concentration of PFAS in a solution comprising:
exposing a treatment solution to a UV light source in a continuous reactor, the continuous reactor comprising one or more lamps, an inlet, an outlet, and one or more mixing baffles, the treatment solution comprising a PFAS, iodide and sulfite, and has a pH of about 8 or more; and
flowing the treatment solution through the continuous reactor from the inlet to the outlet at a flow rate of equal to or greater than 5 gallons per minute while exposing the treatment solution to the UV light;
wherein exposing the treatment solution to UV light in the continuous reactor results in partially or fully defluorinating about 80% or more of the PFAS in the treatment solution.

2. The method of claim 1 wherein the continuous reactor comprises a longitudinal axis and wherein the one or more mixing baffles comprise plates positioned approximately perpendicular to the longitudinal axis.

3. The method of claim 1 wherein the one or more mixing baffles comprise between 1 and 20 mixing baffles.

4. The method of claim 1 wherein the continuous reactor comprises a lineal length along a longitudinal axis and a diameter perpendicular to the longitudinal axis, and wherein the one or more mixing baffles comprises a plurality of baffles in which there are between 1 and 3 mixing baffles per unit of lineal length of the reactor which is equal to the diameter.

5. The method of claim 1 wherein the one or more mixing baffles comprise an open area and a closed area, wherein the open area of the one or more mixing baffles is between about 5 and about 80% a cross-sectional area of the continuous reactor across which the mixing baffle extends.

6. The method of claim 1 wherein the one or more mixing baffles comprise a plurality of openings having a shape and a diameter, wherein the plurality of openings are circular and/or oval in shape and 0.1 to 10 cm in diameter.
